(19) United States
(12) Patent Application Publication
(10) Pub. No.: US 2026/0255193 A1
(43) Pub. Date: Aug. 27, 2026

(54) CONFIGURATION OF RECONFIGURABLE INTELLIGENT SURFACE REPORTING EVENTS

(71) Applicant: QUALCOMM INCORPORATED, San Diego, CA (US)

(72) Inventors: Zhikun Wu, Beijing (CN); Ahmed Elshafie, San Diego, CA (US); Wanshi Chen, San Diego, CA (US); Yu Zhang, San Diego, CA (US); Hung Dinh Ly, San Diego, CA (US)

(21) Appl. No.: 19/102,379

(22) PCT Filed: Sep. 21, 2022
(86) PCT No.: PCT/CN2022/120151

§ 371 Date: Feb. 8, 2025

(51) Int. Cl. H04W 24/08; H04B 7/04

(52) U.S. Cl. CPC H04W 24/08; H04B 7/04013

(57) ABSTRACT

Methods, systems, and devices for wireless communications are described. A first device, such as a network entity or a user equipment (UE), may indicate a status report configuration to a reconfigurable intelligent surface (RIS). The status report configuration may include a set of parameters for transmitting one or more status reports associated with operation of the RIS. For example, the set of parameters may include a trigger event, a status report periodicity, operation information to be included in the status report, a quantity of status reports to be transmitted, or the like. The RIS may transmit one or more status reports to the first device according to the status report configuration. In some examples, the RIS may transmit the one or more status reports to a second device different from the first device, and the second device may forward the one or more status reports to the first device.

### CROSS REFERENCE

This application is a 371 National Stage of PCT Application No. PCT/CN2022/120151, filed on Sep. 21, 2022, entitled “CONFIGURATION OF RECONFIGURABLE INTELLIGENT SURFACE REPORTING EVENTS,” and assigned to the assignee hereof. The disclosure of the prior Application is considered part of and is incorporated by reference into this Patent Application.

### FIELD OF TECHNOLOGY

The following relates to wireless communications, including configuration of reconfigurable intelligent surface (RIS) reporting events.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, two or more devices may communicate with each other via a reflective surface (e.g., a device including one or more reflective surfaces, which may be referred to as a reconfigurable intelligent surface (RIS)). For example, a first device may transmit signaling toward the reflective surface and a second device may receive the signaling reflected off the reflective surface.

### SUMMARY

The described techniques relate to improved methods, systems, devices, and apparatuses that support configuration of reconfigurable intelligent surface (RIS) reporting events. Generally, the described techniques provide for a first device, such as a network entity or a user equipment (UE), to indicate a status report configuration to an RIS. The status report configuration may include a set of parameters for the RIS to transmit one or more status reports associated with operation of the RIS. For example, the set of parameters may include a trigger event for transmitting a status report, a status report periodicity, operation information to be included in the status report, a quantity of status reports to be transmitted by the RIS, or the like, among other examples. The RIS may transmit one or more status reports to the first device according to the status report configuration. In some examples, the RIS may transmit the one or more status reports to a second device different from the first device, and the second device may forward the one or more status reports to the first device.

A method for wireless communications at a first device is described. The method may include transmitting, to a second device including a set of multiple reflective elements, a first message indicating a status report configuration, the status report configuration including a set of parameters for transmitting one or more status reports associated with operations of the second device, transmitting, to the second device, one or more control messages indicating respective communication configurations for the second device, and receiving a status report in accordance with the set of parameters, the status report indicating whether a current operation of the second device corresponds to one of the respective communication configurations.

An apparatus for wireless communications at a first device is described. The apparatus may include a processor, memory coupled with the processor, and instructions stored in the memory. The instructions may be executable by the processor to cause the apparatus to transmit, to a second device including a set of multiple reflective elements, a first message indicating a status report configuration, the status report configuration including a set of parameters for transmitting one or more status reports associated with operations of the second device, transmit, to the second device, one or more control messages indicating respective communication configurations for the second device, and receive a status report in accordance with the set of parameters, the status report indicating whether a current operation of the second device corresponds to one of the respective communication configurations.

Another apparatus for wireless communications at a first device is described. The apparatus may include means for transmitting, to a second device including a set of multiple reflective elements, a first message indicating a status report configuration, the status report configuration including a set of parameters for transmitting one or more status reports associated with operations of the second device, means for transmitting, to the second device, one or more control messages indicating respective communication configurations for the second device, and means for receiving a status report in accordance with the set of parameters, the status report indicating whether a current operation of the second device corresponds to one of the respective communication configurations.

A non-transitory computer-readable medium storing code for wireless communications at a first device is described. The code may include instructions executable by a processor to transmit, to a second device including a set of multiple reflective elements, a first message indicating a status report configuration, the status report configuration including a set of parameters for transmitting one or more status reports associated with operations of the second device, transmit, to the second device, one or more control messages indicating respective communication configurations for the second device, and receive a status report in accordance with the set of parameters, the status report indicating whether a current operation of the second device corresponds to one of the respective communication configurations.

Some examples of the method, apparatuses, and non-transitory computer-readable medium described herein may further include operations, features, means, or instructions for transmitting, to a third device different from the second device, a second message indicating a configuration of a set of status reports to be transmitted by the second device, where the status report may be received from the third device based on the configuration of the set of status reports.

In some examples of the method, apparatuses, and non-transitory computer-readable medium described herein, receiving the status report may include operations, features, means, or instructions for receiving the status report from the second device based on one or more trigger events and the status report configuration.

In some examples of the method, apparatuses, and non-transitory computer-readable medium described herein, the set of parameters includes a quantity of status reports to be transmitted, a status report periodicity, one or more operating parameters associated with the current operation of the second device to be included in the status report, a trigger event for the status report, a bitmap indicating a mapping between a set of communication configurations and a set of symmetric keys, or a combination thereof.

In some examples of the method, apparatuses, and non-transitory computer-readable medium described herein, the one or more operating parameters include a current operating state of the second device, a current configuration of the set of multiple reflective elements of the second device, a quantity of communication configurations received at the second device, a list of communication configurations received at the second device, or a combination thereof.

In some examples of the method, apparatuses, and non-transitory computer-readable medium described herein, the trigger event includes a change in one or more measurement values associated with reception of the one or more control messages at the second device, the one or more measurement values including an angle of arrival (AoA), a reference signal received power (RSRP), a reference signal received quality (RSRQ), a signal-to-interference-plus-noise ratio (SINR), or a combination thereof.

Some examples of the method, apparatuses, and non-transitory computer-readable medium described herein may further include operations, features, means, or instructions for transmitting, to the second device, a third message indicating a resource pattern for the one or more status reports, the resource pattern including a randomized pattern, a frequency hopping pattern, or a combination thereof, where the status report may be received in accordance with the resource pattern.

Some examples of the method, apparatuses, and non-transitory computer-readable medium described herein may further include operations, features, means, or instructions for transmitting, to the second device, a third message indicating a set of radio network temporary identifiers associated with a radio network temporary identifier pattern for the one or more status reports, the radio network temporary identifier pattern including a set of time domain resources corresponding to the set of radio network temporary identifiers, where the status report includes a radio network temporary identifier in accordance with the radio network temporary identifier pattern.

Some examples of the method, apparatuses, and non-transitory computer-readable medium described herein may further include operations, features, means, or instructions for generating a signature associated with the first device based on a symmetric key, the signature including a bit sequence, where the first message includes the signature.

In some examples of the method, apparatuses, and non-transitory computer-readable medium described herein, the status report further indicates a signature associated with the current operation of the second device based on a bitmap between a one or more signatures and a current status of the second device.

Some examples of the method, apparatuses, and non-transitory computer-readable medium described herein may further include operations, features, means, or instructions for comparing, based on the status report, the current operation of the second device to the respective communication configurations to determine whether the current operation of the second device may be legitimate.

A method for wireless communications at a second device including a set of multiple reflective elements is described. The method may include receiving, from a first device, a first message indicating a status report configuration, the status report configuration including a set of parameters for transmitting one or more status reports associated with operations of the second device and transmitting, based on a trigger event, a status report in accordance with the set of parameters, the status report associated with current operation of the second device.

An apparatus for wireless communications at a second device including a set of multiple reflective elements is described. The apparatus may include a processor, memory coupled with the processor, and instructions stored in the memory. The instructions may be executable by the processor to cause the apparatus to receive, from a first device, a first message indicating a status report configuration, the status report configuration including a set of parameters for transmitting one or more status reports associated with operations of the second device and transmit, based on a trigger event, a status report in accordance with the set of parameters, the status report associated with current operation of the second device.

Another apparatus for wireless communications at a second device including a set of multiple reflective elements is described. The apparatus may include means for receiving, from a first device, a first message indicating a status report configuration, the status report configuration including a set of parameters for transmitting one or more status reports associated with operations of the second device and means for transmitting, based on a trigger event, a status report in accordance with the set of parameters, the status report associated with current operation of the second device.

A non-transitory computer-readable medium storing code for wireless communications at a second device including a set of multiple reflective elements is described. The code may include instructions executable by a processor to receive, from a first device, a first message indicating a status report configuration, the status report configuration including a set of parameters for transmitting one or more status reports associated with operations of the second device and transmit, based on a trigger event, a status report in accordance with the set of parameters, the status report associated with current operation of the second device.

Some examples of the method, apparatuses, and non-transitory computer-readable medium described herein may further include operations, features, means, or instructions for receiving, from the first device, one or more control messages indicating respective communication configurations for the second device, where the status report indicates whether the current operation of the second device corresponds to one of the respective communication configurations.

In some examples of the method, apparatuses, and non-transitory computer-readable medium described herein, the set of parameters includes a quantity of status reports, a status report periodicity, one or more operating parameters associated with the operations of the second device, an indication of the trigger event for the status report, a bitmap indicating a mapping between a set of communication configurations and a set of symmetric keys, or a combination thereof.

In some examples of the method, apparatuses, and non-transitory computer-readable medium described herein, the one or more operating parameters include a current operating state of the device, a current configuration of the set of multiple reflective elements of the device, a quantity of one or more communication configurations received at the second device, a list of communication configurations received at the second device, or a combination thereof.

In some examples of the method, apparatuses, and non-transitory computer-readable medium described herein, the trigger event includes a change in one or more measurement values associated with reception of one or more control messages at the second device, the one or more measurement values including an AoA, an RSRP, an RSRQ, an SINR, or a combination thereof.

Some examples of the method, apparatuses, and non-transitory computer-readable medium described herein may further include operations, features, means, or instructions for performing one or more measurements to determine the change in the one or more measurement values based on receiving the one or more control messages.

Some examples of the method, apparatuses, and non-transitory computer-readable medium described herein may further include operations, features, means, or instructions for receiving a second message indicating a resource pattern for the one or more status reports, the resource pattern including a randomized pattern, a frequency hopping pattern, or a combination thereof, where the status report may be transmitted in accordance with the resource pattern.

Some examples of the method, apparatuses, and non-transitory computer-readable medium described herein may further include operations, features, means, or instructions for receiving a second message indicating a set of radio network temporary identifiers associated with a radio network temporary identifier pattern for the one or more status reports, the radio network temporary identifier pattern including a set of time domain resources corresponding to the set of radio network temporary identifiers, where the status report includes a radio network temporary identifier in accordance with the radio network temporary identifier pattern.

In some examples of the method, apparatuses, and non-transitory computer-readable medium described herein, the first message further indicates a signature associated with the first device and based on a symmetric key and the status report further indicates a signature associated with the current operation of the second device based on a bitmap between a one or more signatures and a current status of the second device.

In some examples of the method, apparatuses, and non-transitory computer-readable medium described herein, transmitting the status report may include operations, features, means, or instructions for transmitting the status report to a third device different from the first device based on the status report configuration.

Some examples of the method, apparatuses, and non-transitory computer-readable medium described herein may further include operations, features, means, or instructions for receiving a third message from the third device, where receiving the third message includes the trigger event, and where transmitting the status report to the third device may be in response to receiving the third message.

A method for wireless communications at a UE is described. The method may include communicating with a first device via a second device, the second device including a set of multiple reflective elements, receiving, from the second device, a status report associated with current operation of the second device, where the status report is received in response to a trigger event, and transmitting, to the first device, a first message indicating the status report received from the second device.

An apparatus for wireless communications at a UE is described. The apparatus may include a processor, memory coupled with the processor, and instructions stored in the memory. The instructions may be executable by the processor to cause the apparatus to communicate with a first device via a second device, the second device including a set of multiple reflective elements, receive, from the second device, a status report associated with current operation of the second device, where the status report is received in response to a trigger event, and transmit, to the first device, a first message indicating the status report received from the second device.

Another apparatus for wireless communications at a UE is described. The apparatus may include means for communicating with a first device via a second device, the second device including a set of multiple reflective elements, means for receiving, from the second device, a status report associated with current operation of the second device, where the status report is received in response to a trigger event, and means for transmitting, to the first device, a first message indicating the status report received from the second device.

A non-transitory computer-readable medium storing code for wireless communications at a UE is described. The code may include instructions executable by a processor to communicate with a first device via a second device, the second device including a set of multiple reflective elements, receive, from the second device, a status report associated with current operation of the second device, where the status report is received in response to a trigger event, and transmit, to the first device, a first message indicating the status report received from the second device.

Some examples of the method, apparatuses, and non-transitory computer-readable medium described herein may further include operations, features, means, or instructions for transmitting, to the second device, a second message indicating that the second device may be to transmit the status report to the UE, where transmitting the second message includes the trigger event, and where the status report may be received in response to the second message.

In some examples of the method, apparatuses, and non-transitory computer-readable medium described herein, the trigger event includes a change in one or more measurement values associated with reception of one or more control messages, the one or more measurement values including an AoA, an RSRP, an RSRQ, an SINR, or any combination thereof.

Some examples of the method, apparatuses, and non-transitory computer-readable medium described herein may further include operations, features, means, or instructions for performing one or more measurements to determine the change in the measurement value based on the one or more control messages.

Some examples of the method, apparatuses, and non-transitory computer-readable medium described herein may further include operations, features, means, or instructions for receiving, from the first device, a third message indicating a configuration of a set of status reports to be transmitted by the second device, where receiving the status report may be based on the configuration of the set of status reports.

### BRIEF DESCRIPTION OF THE DRAWINGS

FIG. 1 illustrates an example of a wireless communications system that supports configuration of reconfigurable intelligent surface (RIS) reporting events in accordance with one or more aspects of the present disclosure.

FIG. 2 illustrates an example of a wireless communications system that supports configuration of RIS reporting events in accordance with one or more aspects of the present disclosure.

FIG. 3 illustrates an example of a signaling diagram that supports configuration of RIS reporting events in accordance with one or more aspects of the present disclosure.

FIG. 4 illustrates an example of a process flow in a system that supports configuration of RIS reporting events in accordance with one or more aspects of the present disclosure.

FIGS. 5 and 6 show block diagrams of devices that support configuration of RIS reporting events in accordance with one or more aspects of the present disclosure.

FIG. 7 shows a block diagram of a communications manager that supports configuration of RIS reporting events in accordance with one or more aspects of the present disclosure.

FIG. 8 shows a diagram of a system including a device that supports configuration of RIS reporting events in accordance with one or more aspects of the present disclosure.

FIGS. 9 and 10 show block diagrams of devices that support configuration of RIS reporting events in accordance with one or more aspects of the present disclosure.

FIG. 11 shows a block diagram of a communications manager that supports configuration of RIS reporting events in accordance with one or more aspects of the present disclosure.

FIG. 12 shows a diagram of a system including a device that supports configuration of RIS reporting events in accordance with one or more aspects of the present disclosure.

FIGS. 13 and 14 show block diagrams of devices that support configuration of RIS reporting events in accordance with one or more aspects of the present disclosure.

FIG. 15 shows a block diagram of a communications manager that supports configuration of RIS reporting events in accordance with one or more aspects of the present disclosure.

FIG. 16 shows a diagram of a system including a device that supports configuration of RIS reporting events in accordance with one or more aspects of the present disclosure.

FIGS. 17 through 22 show flowcharts illustrating methods that support configuration of RIS reporting events in accordance with one or more aspects of the present disclosure.

### DETAILED DESCRIPTION

Some wireless communications systems may include one or more reconfigurable intelligent surfaces (RISs) (or a wireless device including an RIS, or a device controlling operations of a RIS, which may sometimes be referred to as an RIS controller) that reflect signaling between other devices (e.g., between a network entity and a user equipment (UE), between two UEs). In some cases, an RIS, which may be an example of a reflective surface or a device including various reflective elements, may extend a coverage area of a device or may otherwise support a communication link between the device and one or more other devices. For example, the RIS may reflect signaling around blockages such that two devices may communicate despite any obstruction. An RIS may be understood to include or be at least a two-dimensional antenna array that includes a set of reflective elements (e.g., individual scattering elements). Each reflective element may be configured according to a phase configuration such that the RIS reflects signals to or from some direction. Some RISs may be associated with a relatively large quantity of configurations of the surface (for different reflection directions), where different configurations of the surface correspond to different pairs of a receive beam and a reflected beam at an RIS. In some cases, a device (e.g., a network entity, a UE) may transmit signaling to the RIS (e.g., to a controller of the RIS) indicating a phase configuration for each of the set of reflective elements of the RIS. The RIS may configure the surface according to the indicated phase configuration.

In addition to operating with relatively low power consumption, RISs may have relatively simple (e.g., low complexity) structures and may be relatively low-cost. A device (e.g., a network entity, a UE) may configure a RIS using lower-layer control signaling, such as layer 1 (e.g., physical layer (PHY)) or layer 2 (e.g., medium access control (MAC) layer) signaling. In some cases, however, such control signaling may be vulnerable to malicious attacks from unauthorized devices. Further, some RISs may not be able to verify whether a received signal originated at a valid source. For example, a malicious device may transmit an unauthorized communication configuration to an RIS, such that the RIS is configured to be in an unintended state (e.g., different than a state associated with a communication configuration transmitted by an authorized network entity). The unauthorized communication configuration may switch the RIS off, resulting in disruption to communications for any devices utilizing the RIS. In other examples, the unauthorized communication configuration may configure the RIS to reflect signals in a direction that causes jamming, interference, or a decrease in signal strength. Thus, unauthorized and/or malicious control of an RIS may affect communications in a wireless communications system in various ways.

Accordingly, the techniques described herein support configuration of status reports to be transmitted by a RIS, where a status report indicates operation information associated with the RIS, which may provide early detection of unauthorized configurations of the RIS, thereby minimizing or avoiding impact to communications efficiency and other issues. A device may monitor status reports received from the RIS to detect unauthorized configurations at the RIS. For example, a device (e.g., a network entity, a UE) may indicate one or more communication configurations to a RIS. Additionally, the device may transmit, to the RIS, control signaling indicating a status report configuration, such as a set of parameters to be used by the RIS for transmitting one or more status reports. The RIS may transmit a status report based on the status report configuration, where the status report indicates a current operating state of the RIS, a current configuration of the set of reflective elements of the RIS, a quantity of communication configurations received at the RIS, a list of communication configurations received at the RIS, or a combination thereof, among other examples. The device may receive the status report and may compare the operation information included in the status report to the one or more communication configurations indicated by the device. If the operation information does not align with (e.g., match, correspond to) the one or more communication configurations (e.g., a most recent communication configuration), the device may determine that the RIS has received or is operating according to an unauthorized configuration. In some examples, the device may indicate another communication configuration to return the RIS to an intended configuration. In other examples, the device may deactivate the RIS or perform other actions to avoid issues associated with unauthorized or malicious attacks on the RIS.

Additionally, the described techniques support methods for verifying validity of messages received at the device and the RIS. For example, the device may generate a signature to include in the status report configuration, which may enable the RIS to verify the status report configuration. The RIS may include the signature in the status report so that the device may verify the validity of the status report. Additionally, the RIS may transmit the status report according to a configured pattern (e.g., a resource element pattern, an identifier pattern), which may enable the device to verify the validity of the status report. In some cases, the RIS may transmit the status report according to a trigger event, such as a change in measurement values associated with receiving control messages from the device. For example, control signaling received at the RIS from a new angle of arrival (AoA) may indicate that the control signaling originated at an unauthorized device, and the RIS may be triggered to transmit the status report to the device.

Aspects of the disclosure are initially described in the context of wireless communications systems. Aspects of the disclosure are then discussed with reference to a signaling diagram and a process flow. Aspects of the disclosure are further illustrated by and described with reference to apparatus diagrams, system diagrams, and flowcharts that relate to configuration of RIS reporting events.

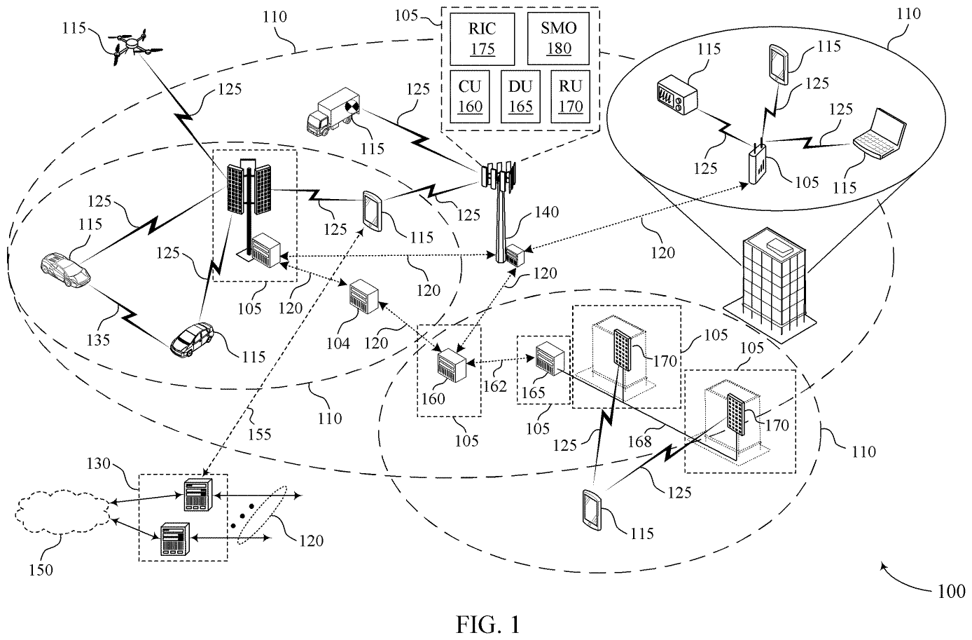

FIG. 1 illustrates an example of a wireless communications system 100 that supports configuration of RIS reporting events in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support configuration of RIS reporting events as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the wireless communications system 100 may employ massive MIMO (such as 5G massive MIMO) to increase an achievable throughput between two communicating devices, and may extend coverage via one or more active antenna units or one or more passive reflective surfaces (such as RISs), or any combination thereof. For example, devices in the wireless communications system 100 may achieve a relatively higher beamforming gain by using active antenna units (e.g., devices capable of supporting active antenna units, such as network entities 105, UEs 115, relay nodes, smart repeaters, or the like). In some aspects, such active antenna units may be associated with a use of individual RF chains per antenna ports. Such systems may experience a significant increase in power consumption due to the use of active antenna units.

Some systems (such as the wireless communications system 100) may, in addition or as an alternative to deploying additional active antenna units, employ the use of one or more assisting devices, such as one or more RISs, to extend coverage (such as 5G coverage) with a negligible or relatively small increase in power consumption (e.g., as compared to active antenna units). For example, some systems may leverage passive MIMO as a substitute for an active antenna unit. An RIS may be a near-passive device capable of reflecting an impinging or incident wave to a desired location or in a desired direction.

For example, the wireless communications system 100 may include one or more RISs to extend wireless communications coverage around or because of blockages between devices (e.g., between a network entity 105 and a UE 115, between two UEs 115). For example, a network entity 105 and a UE 115 may attempt to establish a communication link with each other using a beamforming technique and via an assisting device controlled by an assisting node. Such an assisting device may include or be an example of an RIS and such an assisting node may include or be an example of a central unit (CU) or some other device capable of CU functionality (e.g., any device capable of wirelessly transmitting or receiving or capable of configuring or otherwise controlling one or more assisting devices).

An RIS (which may sometimes be referred to as a smart surface, a passive access point, or other similar terminology) may extend a coverage area of a device or may otherwise support a communication link between devices by reflecting beams in one or more target directions. For example, the RIS may reflect beams around blockages so that a device may communicate in the presence of blockages. In some cases, the RIS may consume relatively low power to reflect transmissions (e.g., when compared to a device transmitting beamformed signals using an active antenna unit). That is, the RIS may passively reflect beams according to a configured (i.e., target) direction. A network entity 105 or a UE 115 may configure (e.g., control) the RIS (e.g., by way of the assisting node) to reflect transmissions according to the configured direction. The RIS may include a set of reflective elements (e.g., N reflective elements) that may each be configured according to a phase configuration such that the RIS reflects signals to or from the configured direction. For example, the RIS may include a control unit (which may also be referred to herein as an RIS controller) that may receive signaling from a device (e.g., from a network entity 105, from a UE 115) and set the phase configuration of each reflective element. In some examples, the RIS may include reflective elements in two dimensions, and may reflect one or more beams (e.g., in one or more directions, such as symmetric directions).

In some cases, the device may configure the N reflective elements of the RIS in order to improve a channel between the device and another device. For example, a network entity 105 may configure the N reflective elements of the RIS in order to improve a channel between the network entity 105 and a UE 115. In some cases, the channel between the network entity 105 and the UE 115 via an RIS with N reflective elements may be based on one or more communication parameters, such as an element spacing of the reflective elements, an AoA of a signal from the network entity 105 to the RIS, a wavelength of the signal, or the like, among other examples. Thus, the network entity 105 may configure the RIS (e.g., may configure the N reflective elements) with a communication configuration based on the one or more communications parameters, e.g., to increase a signal strength between the network entity 105 and the UE 115. For example, the network entity 105 may transmit signaling to the RIS indicating a communication configuration such that the RIS reflects signals in a target direction according to the communication configuration. In some examples, the communication configuration may correspond to a phase configuration for one or more reflective elements of the set of reflective elements of the RIS. For example, for each reflective element N, the network entity 105 may determine a respective phase configuration. Alternatively, the network entity 105 may determine a phase configuration per subset of reflective elements of the set of reflective elements.

According to the techniques described herein, a device that configures an RIS may configure one or more status reports to be transmitted by the RIS. The device, such as a network entity 105 or a UE 115, may transmit a message indicating a status report configuration to the RIS. The status report configuration may include one or more parameters to be used by the RIS for transmitting one or more status reports. For example, the one or more parameters may include a quantity of status reports to be transmitted, a status report periodicity, one or more operating parameters associated with a current operation of the RIS to be included in the status report, a trigger event for transmitting the status report, a bitmap indicating a mapping between a set of communication configurations and a set of symmetric keys, or a combination thereof. The one or more operating parameters may include a current operating state of the RIS, a current configuration of the plurality of reflective elements of the RIS, a quantity of communication configurations received at the RIS, a list of communication configurations received at the RIS, or a combination thereof. The RIS may transmit a status report based on the status report configuration. The device may monitor status reports received from the RIS to detect unauthorized configurations at the RIS. For example, the device may compare operation information indicated in the status report to communication configurations transmitted by the device to determine if the RIS has received any communication configurations from an illicit device.

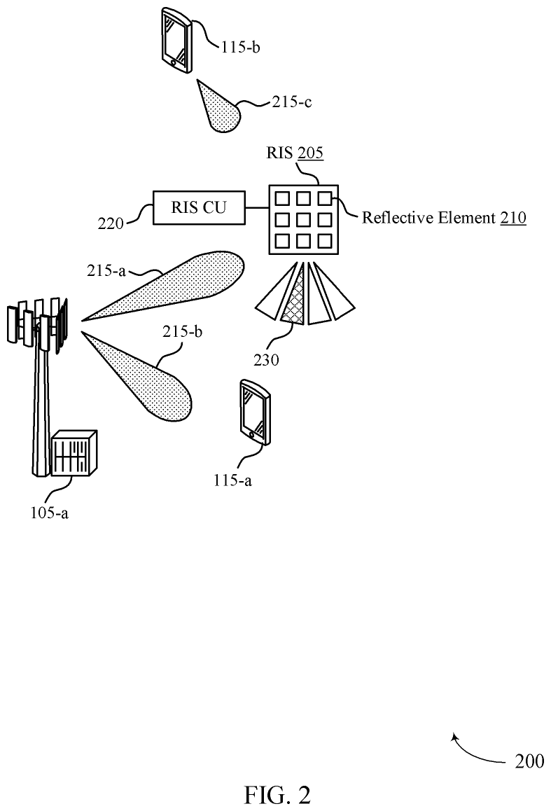

FIG. 2 illustrates an example of a wireless communications system 200 that supports configuration of RIS reporting events in accordance with one or more aspects of the present disclosure. The wireless communications system 200 may implement or be implemented to realize aspects of the wireless communications system 100. For example, the wireless communications system 200 may include a network entity 105-a, a UE 115-a, and a UE 115-b, which may be examples of corresponding devices as described with reference to FIG. 1. Additionally, the wireless communications system 200 may include an RIS 205 with a set of reflective elements 210. While the RIS 205 includes nine illustrated reflective elements 210, the RIS 205 may include a different quantity of reflective elements 210, such as more than nine reflective elements 210 (e.g., one thousand reflective elements 210, four thousand reflective elements 210).

Wireless communications system 200 may support MIMO techniques, which may in turn support increases in throughput (e.g., as compared to wireless communications systems that do not support MIMO techniques). In some cases, to support MIMO techniques, devices in the wireless communications system 200 (e.g., the network entity 105-a, the UEs 115) may communicate via beams 215 associated with relatively high beamforming gains using active antenna units. This may include configuring individual RF chains per antenna port. However, this approach may be associated with a significant increase in power consumption due to the use of the active antenna units. Accordingly, wireless communications system 200 may deploy the RIS 205 to extend coverage (e.g., around a blockage) with negligible power consumption (e.g., as compared to an active antenna unit). For example, the RIS 205 may be a near-passive device capable of reflecting an impinging or incident wave to a desired location or in a desired direction.

An RIS 205 may function similarly to a reflector or other type reflective surface in its ability to reflect incident beams or waves (such as light waves, radio waves), but may differ in that an RIS 205 may include one or more components that are able to control or dictate how an incident beam or wave is reflected (such that an angle of incidence can be different than an angle of reflection) or that are able to control or dictate a shape of a reflected beam or wave (such as via energy focusing or energy nulling via constructive interference or destructive interference, respectively), or both. For example, the set of reflective elements 210 included in an RIS 205 may each have a controllable delay, phase, or polarization, or any combination thereof. Thus, each reflective element 210 may be controlled or configured to direct reflection of an incident beam or wave or to control a shape of a reflected beam or wave. An RIS 205 may be an example of or may otherwise be referred to as a software-controlled metasurface, a configurable reflective surface, a reflective intelligent surface, a configurable intelligent surface, or other terminology, and the RIS 205 may sometimes be a metal surface (such as a copper surface) including a quantity of reflective elements 210, among other examples.

In some aspects, an RIS CU 220 may be coupled with an RIS 205 via hardware (such as via a fiber optic cable). In some other aspects, an RIS CU 220 may be non-co-located with an RIS 205 and may configure the RIS 205 via over-the-air signaling. In some aspects, the RIS CU 220 may have both transmission and reception capabilities. The RIS CU 220 may also be referred to as an RIS controller and may be an example of a CU, a node, or any device with CU capabilities. The RIS CU 220 may control the RIS 205 by configuring one or more reflection characteristics of the RIS 205 to control the reflection direction from the RIS 205. For example, the RIS CU 220 may control or configure each of the reflective elements 210 to control how an incident beam or wave is reflected, or to control a shape of a reflected beam or wave. In some cases, another device (e.g., different from the RIS CU 220), such as a UE (e.g., a UE 115) or a network entity (e.g., the network entity 105-a) may configure or control RIS CU 220 (such that the device may effectively configure or control the reflection direction of the RIS 205).

For example, the RIS 205 (e.g., the RIS CU 220) may receive a communication configuration from another device, such as the network entity 105-a or a UE 115. The communication configuration may be understood as a configuration for the RIS 205, e.g., for the set of reflective elements 210 of the RIS 205. The device may select a communication configuration that achieves a desired shape or reflection direction of a beam (i.e., signal) transmitted in the direction of the RIS 205. In some aspects, a communication configuration of the RIS 205 may be associated with a receive beam, such as a directional beam or configuration for directional “reception” of signaling, and a reflected beam, such a directional beam or configuration for directional reflection of the signaling. For instance, the communication configuration may indicate a beam associated with a transmission to be reflected by the RIS 205 (e.g., to a receiving device). Additionally, or alternatively, the communication configuration may indicate an index associated with the beam, or may indicate a summation associated with an AoA (e.g., at the RIS 205) associated with the beam and an angle of departure (e.g., from the RIS 205) associated with the beam. In some examples, a communication configuration may indicate respective configurations for each of one or more individual reflective elements 210, may indicate one or more respective configurations for each of one or more subsets of reflective elements 210, or may indicate a configuration for the set of reflective elements 210. In any case, the RIS 205 (e.g., the RIS CU 220) may configure the reflective elements 210 according to the received communication configuration such that a signal (e.g., a receive beam) received at the RIS 205 is reflected (e.g., as a reflected beam) in the intended direction.

As illustrated in the wireless communications system 200, for example, the RIS 205 may support a communication link between the network entity 105-a and the UE 115-a by reflecting communications from the network entity 105-a (e.g., directed from the network entity 105-a to the RIS 205) to the UE 115-a via a beam 230 (e.g., directed from the RIS 205 to the UE 115-a). For example, the network entity 105-a may transmit messaging (e.g., control signaling) to the RIS CU 220 indicating a configuration of the RIS 205 to achieve the appropriate reflection direction of the beam 230, and the RIS CU 220 may configure the RIS 205 accordingly. In some cases, the RIS 205 may reflect a beam (e.g., the beam 230) according to a direction that is based on a phase configuration of each of the reflective elements 210 of the RIS 205. For example, the RIS 205 may set a phase configuration of each of the reflective elements 210 to adjust an angle of departure of a beam reflected by the RIS 205. Further, although described herein as a “receive” beam, a receive beam associated with a configuration of the RIS 205 may refer to reception as part of a reflecting (as opposed to, for example, as part of a decoding).

In some scenarios, a malicious device may attempt to control the RIS 205 into an unauthorized configuration or state. For example, as illustrated in FIG. 2, the network entity 105-a and the UE 115-a may be examples of authorized (e.g., valid, legitimate) devices, such that communication configurations transmitted to the RIS 205 (e.g., to the RIS CU 220) may be considered authorized (e.g., valid, legitimate) configurations. Specifically, the network entity 105-a may transmit downlink control signaling indicating one or more communication configurations (e.g., authorized communication configurations) to the RIS 205 via a beam 215-a, e.g., to configure the RIS 205 to support communications between the network entity 105-a and the UE 115-a. To enable the RIS 205 to decode the control signaling and implement the configuration with relatively low latency, the network entity 105-a may utilize L1/L2 signaling, such as PHY layer signaling or MAC layer signaling, for transmission of the communication configuration(s). Due to its relatively simple structure, however, L1/L2 signaling may be easily replicated by a malicious device, and the RIS 205 may be unable to distinguish between authorized configurations and unauthorized configurations.

For instance, the UE 115-b may be a malicious (e.g., unauthorized, invalid, illegitimate) device. The UE 115-b may transmit an unauthorized communication configuration to the RIS 205 via a beam 215-c. If the RIS 205 configures itself based on the unauthorized communication configuration, the RIS 205 may no longer be able to reflect the beam 230 in the direction of the UE 115-a. For example, the unauthorized communication configuration may configure the RIS 205 into a different direction such that the beam 230 experiences jamming or interference, or such that a signal transmitted via the beam 230 is relatively weak (e.g., compared to the authorized configuration). Additionally, or alternatively, the unauthorized communication configuration may configure the RIS 205 to switch to an off state.

To avoid or mitigate such attacks, the RIS 205 (e.g., the RIS CU 220) may be configured to transmit one or more status reports to a controlling device, such as the network entity 105-a or a UE 115 (e.g., the UE 115-a). The controlling device may be a same device that transmits communication configurations to the RIS 205, or may be different from a device that transmits communication configurations to the RIS 205. A status report may indicate information related to operations at the RIS 205, such as a list of configurations received or implemented at the RIS 205 over a given time period. The controlling device may analyze operation information in the status report to determine if the RIS 205 has received unauthorized communications from a malicious device. In some cases, the controlling device may compare a list of configurations received by the RIS 205 to a record (e.g., history) of authorized configurations (e.g., transmitted by the controlling device) to identify any mismatches. For example, if the list of configurations received by the RIS 205 includes an extra configuration, e.g., one that is not included in the record of authorized configurations, the controlling device may determine that the extra configuration was unauthorized (e.g., originated from an unauthorized device). Thus, status reports transmitted by the RIS 205 may enable the controlling device to monitor for attacks on the RIS 205.

In the example of FIG. 2, the network entity 105-a may transmit, to the RIS 205 via the beam 215-a, control signaling (e.g., one or more control messages) indicating one or more communication configurations for the RIS 205. The network entity 105-a may additionally transmit, to the RIS 205, a message indicating a status report configuration to configure reporting events for the RIS 205. A reporting event may refer to transmission of a status report by the RIS 205. The message may include or be an example of control signaling, such as L1, L2, or L3 (e.g., PHY layer, MAC layer, or radio resource control (RRC) layer) signaling (e.g., a physical downlink shared channel (PDSCH) message, a physical downlink control channel (PDCCH) message, downlink control information (DCI), a MAC control element (MAC-CE), an RRC message).

While the examples described herein are discussed with reference to the network entity 105-a transmitting the control signaling indicating the communication configuration(s) and the status report configuration, it is to be understood that any device may configure the RIS 205. For example, the UE 115-a may transmit the control signaling indicating the one or more communication configurations and the status report configuration to the RIS 205. In such examples, the UE 115-a may utilize uplink signaling or sidelink signaling to communicate with the RIS 205. That is, the control signaling transmitted by the UE 115-a may be an example of uplink control information (UCI), sidelink control information (SCI), a physical sidelink shared channel (PSSCH) message, a physical sidelink control channel (PSCCH), or the like.

The status report configuration may include a set of parameters for the RIS 205 to use to transmit one or more status reports associated with operations of the RIS 205. The set of parameters may include transmission parameters for the one or more status reports, such as a periodicity, a set of resources (e.g., time resources, frequency resources, spatial resources), or the like. In some cases, the set of parameters may include a quantity of status reports to be transmitted by the RIS 205, e.g., within an indicated time period. The time period may be indicated by a time duration, an initial start time, an end time, a quantity of reporting events, or a combination thereof.

Additionally, or alternatively, the set of parameters may indicate information (e.g., operation information, operating parameters) to be included in a status report, such as a current operating state of the RIS 205, one or more past operating states of the RIS 205, a current configuration of the RIS 205 (e.g., a current configuration of the set of reflective elements 210), one or more past configurations of the RIS 205, a quantity of all or a subset of communication configurations received at the RIS 205 (e.g., within an indicated time period), a list of all or a subset of communication configurations received at the RIS 205 (e.g., within an indicated time period), or a combination thereof. For example, a status report may indicate whether a current operation of the RIS 205 corresponds to a communication configuration transmitted by the network entity 105-a. In some examples, the indicated time period may be defined as a time period between reporting events. For example, the RIS 205 may be configured to report a quantity of communication configurations received since the RIS 205 transmitted a previous status report. Put another way, the quantity of communication configurations may be received at the RIS 205 between two reporting events, e.g., during a time period beginning after the RIS 205 transmitted a previous status report and ending when the RIS 205 transmits the current status report.

The status report may have a report length in bits, e.g., may include a quantity of bits indicating the operation information, where the quantity of bits may depend on the type of signaling used for the status report. For example, the RIS 205 may transmit the status report as an L1/L2 signal (e.g., via a PHY/MAC layer), which may be associated with a limited quantity of bits (e.g., 3 bits). The RIS 205 may modify the operation information to align with the limited quantity of bits. For instance, the RIS 205 may be configured to report a quantity of communication configurations received during a given time period (which may be indicated by the set of parameters), but the quantity of communication configurations received may be greater than the quantity of bits available for the status report. In such cases, the RIS 205 may apply a modulo operation to the operation information based on the limited quantity of bits, as shown below in Equation 1.

$$C mod ( {r}^{b} ) = x \qquad ( 1 )$$

In Equation 1, C represents the quantity of configurations received at the RIS 205, r represents the quantity of reports transmitted by the RIS 205 between which the quantity of configurations is received, b represents the limited quantity of bits, and x represents the value indicated in the status report. That is, x is a value that represents the operation information to be reported by the RIS 205. As an illustrative example, if the RIS 205 received nine communication configurations between transmission of a first status report and a second status report (e.g., between two status reports), and there are three bits available for transmitting the status report, x may be equal to 1, and the RIS 205 may indicate a value of one (1) in the status report.

In some examples, the set of parameters may include an indication of a trigger event (e.g., an event that triggers the RIS 205 to transmit a status report), such that the RIS 205 transmits a status report upon occurrence of the trigger event. The trigger event may be, for example, a change in channel conditions between the network entity 105-a and the RIS 205, a change in a measurement value associated with reception of a beam at the RIS 205, or the like. Additionally, or alternatively, the trigger event may indicate a quantity of status reports to be transmitted by the RIS 205 within an indicated time period. Here, the RIS 205 may begin transmitting a first status report of the quantity of status reports based on the indicated time period.

Measurement values to be monitored by the RIS 205 may include an AoA, a reference signal received power (RSRP), a reference signal received quality (RSRQ), a signal-to-interference-plus-noise ratio (SINR), or the like. The RIS 205 may perform measurements of signals received at the RIS 205 over time and may transmit a status report upon a change in one or more of the measurement values. For example, the RIS 205 may perform measurements on control messages received from the network entity 105-a, such as control messages indicating communication configurations. As an example, the RIS 205 may expect to receive communications from the network entity 105-a via the beam 215-a, which, due to the stationary nature of the network entity 105-a, may be associated with an AoA at the RIS 205. If the RIS 205 receives signaling (e.g., a communication configuration) via a beam associated with a different AoA, such as the beam 215-c originating from the UE 115-b, the RIS 205 may be triggered to transmit a status report to the network entity 105-a. The network entity 105-a may receive the status report indicating that the RIS 205 received an unauthorized communication configuration.

In some examples, a device other than the network entity 105-a may be configured to receive status reports from the RIS 205. For instance, a UE 115 that is served by the RIS 205 (e.g., a UE 115 that receives signaling from the RIS 205, such as a UE 115 that communicates with the network entity 105-a by way of the RIS 205) may be configured to collect status reports from the RIS 205 and, in some cases, may forward the status reports to the network entity 105-a. The network entity 105-a may, for example, transmit a message to the UE 115-a via a beam 215-b, where the message indicates a configuration associated with status reports to be transmitted by the RIS 205. The configuration may enable the UE 115-a to discern whether a transmission received from the RIS 205 is a reflected signal originating from the network entity 105-a or is a status report originating at the RIS 205. That is, the UE 115-a may identify that a transmission received from the RIS 205 is a status report if the transmission aligns with the configuration. For example, the UE 115-a may expect that the RIS 205 transmits status reports according to a format specified by the configuration. Additionally, the configuration may indicate that the UE 115-a is to forward (e.g., relay) received status reports to the network entity 105-a.

In such examples, the UE 115-a may further be configured to trigger the RIS 205 to transmit a status report. Here, the UE 115-a may perform measurements associated with reception of one or more signals (e.g., control signals) at the RIS 205. If the UE 115-a determines that a change in one or more measurement values has occurred, the UE 115-a may trigger the status report by transmitting a control message to the RIS 205 instructing the RIS 205 to transmit the status report to the UE 115-a. Thus, the trigger event indicated in the status report configuration for the RIS 205 may, in some cases, include receiving a trigger control message at the RIS 205.

The RIS 205 may transmit status reports according to a timing that is based on a type of signaling associated with the status report, e.g., in addition to any periodicity indicated by the status report configuration. For example, the RIS 205 may transmit the status report relatively frequently (e.g., every 20 ms) if the status report utilizes L1/L2 signaling. Such lower layer signaling may also be associated with reduced overhead. In contrast, higher layer signaling may be associated with relatively large reporting periods (e.g., every 10 seconds). However, higher layer signaling may support encryption of the status report, where lower layer signaling may not. That is, lower layer signaling may be susceptible to imitation (e.g., attacks) by a malicious device, such as the UE 115-b. For example, the UE 115-b may create a false status report that appears to be from the RIS 205. By transmitting the false (e.g., invalid, illegitimate) status report to the network entity 105-a, the UE 115-b may mislead the network entity 105-a, e.g., to cover up or hide any malicious activity by the UE 115-b at the RIS 205.

To avoid or mitigate false status reports, the network entity 105-a may configure a transmission pattern for status reports transmitted by the RIS 205, where the transmission pattern acts as an encryption method. That is, the network entity 105-a may verify a received status report as originating from the RIS 205 as long as the status report is transmitted in accordance with the configured transmission pattern. In a first example, the network entity 105-a may determine a resource element pattern for resources (e.g., time resources and frequency resources) over which the RIS 205 transmits one or more status reports. The resource element pattern may include a set of randomized (or pseudo-randomized) resources. In some cases, the resource element pattern may include or be an example of a frequency hopping pattern. The RIS 205 may transmit each status report in a respective subset of resources of the set of randomized resources in accordance with the resource element pattern.

In a second example, the network entity 105-a may determine a radio network temporary identifier (RNTI) pattern for a set of RNTIs associated with status reports transmitted by the RIS 205. The RIS 205 may select a respective RNTI of the set of RNTIs to include in each transmitted status report in accordance with the RNTI pattern. The RNTI pattern may be time dependent, such that the RIS 205 may switch an RNTI included in a status report according to a time-based pattern. That is, the RNTI selected by the RIS 205 to be included in a status report may change periodically over time, for example, based on a timer, a time-domain resource corresponding to the status report, or the like.

In some examples, the RIS 205 may be preconfigured with the resource element pattern, the RNTI pattern, or both. In other examples, the network entity 105-a may transmit a pattern configuration message indicating the resource element pattern, the RNTI pattern (e.g., indicating the set of RNTIs, the RNTI pattern, a timer associated with the RNTI pattern, a set of time-domain resources associated with the RNTI pattern, or a combination thereof), or both. Here, the pattern configuration message may be transmitted via higher layer signaling (e.g., RRC signaling) and may be encrypted by the network entity 105-a to prevent any malicious devices (e.g., the UE 115-b) from obtaining the patterns. Additionally, or alternatively, the network entity 105-a may dynamically update the resource element pattern or the RNTI pattern over time, e.g., by transmitting subsequent pattern configuration messages to indicate updated transmission patterns.

In some cases, the network entity 105-a may further support secure communications with the RIS 205 by way of an authentication signature (such as a PHY layer digital signature) attached to a communication configuration of the RIS 205, which may be based on or associated with a private key (e.g., a symmetric key). In some examples, the network entity 105-a may generate the authentication signature based on a configuration of the RIS 205 (e.g., a communication configuration), such as a phase configuration (e.g., beam weight) of one or more reflective elements 210 of the RIS 205. The authentication signature may include or be an example of a sequence (e.g., a bit sequence), a commitment value (e.g., associated with a commitment key), or the like. The network entity 105-a may include the authentication signature within control signaling (e.g., indicating a communication configuration, a status report configuration, or both) transmitted to the RIS 205. The RIS 205 may verify that the control signaling is from an authorized source (e.g., from the network entity 105-a) based on the authentication signature being associated with a phase configuration of a reflective element 210 of the RIS 205. That is, if a control message includes an authentication signature corresponding to a phase configuration that is not currently implemented at the RIS 205, the RIS 205 may determine that the control message is invalid and may discard the control message.

In some examples, the network entity 105-a may determine a bitmap indicating a relationship (e.g., a mapping) between one or more communication configurations and one or more authentication signatures. For example, the bitmap may indicate that a first communication configuration corresponds to a first authentication signature, a second communication configuration corresponds to a second authentication signature, and so on, for a quantity of communication configurations and authentication signatures. The network entity 105-a may indicate the bitmap to the RIS 205 as part of the status report configuration (e.g., the bitmap may be an example of a parameter of the set of parameters). When transmitting control signaling indicating a communication configuration to the RIS 205, the network entity 105-a may include, in the control signaling, an authentication signature that corresponds to the indicated communication configuration, e.g., based on the bitmap. The RIS 205 may verify the authenticity of the control signaling based on the authentication signature and the bitmap. For example, the RIS 205 may check (e.g., using the bitmap) if the authentication signature corresponds to the indicated communication configuration. If the authentication signature and the indicated communication configuration do not correspond to one another based on the bitmap, the RIS 205 may determine that the control signaling is unauthorized.

If the RIS 205 receives an authentication signature as part of a valid (e.g., authorized) control message, the RIS 205 may include the authentication signature in a status report transmitted to the network entity 105-a to indicate that the status report is from the RIS 205 (e.g., is not from an unauthorized device). For example, the RIS 205 may transmit a status report indicating an authentication signature associated with a current operation (or configuration) of the RIS 205. The authentication signature may be based on the bitmap indicated in the status report configuration.

Upon reception of a status report from the RIS 205, the network entity 105-a may verify the status report and the operation information indicated by the status report. For example, the network entity 105-a may verify that the status report originated at the RIS 205 by checking that a signature included in the status report matches the signature generated at the network entity 105-a and included in a control message to the RIS 205. The network entity 105-a may compare the operation information to information associated with the RIS 205 and known by the network entity 105-a to identify whether the RIS 205 has been tampered with by a malicious device (e.g., the UE 115-b). The network entity 105-a may, for example, determine whether a quantity of communication configurations received at the RIS 205 and indicated in the status report is the same as a quantity of configurations transmitted by the network entity 105-a. Additionally, or alternatively, the network entity 105-a may determine whether a list of communication configurations received at the RIS 205 (and indicated in the status report) includes only communication configurations transmitted by the network entity 105-a, e.g., does not include any additional communication configurations originating from another device (such as the UE 115-b).

In some cases, if the network entity 105-a determines that the RIS 205 has been attacked by a malicious device (e.g., has received unauthorized communication configurations), the network entity 105-a may assume that the RIS 205 is controlled by the malicious device. The network entity 105-a may transmit a report to a network operator to indicate that the RIS 205 has been compromised. Additionally, or alternatively, the network entity 105-a may temporarily shut down the RIS 205. For example, the network entity 105-a may transmit a control message to the RIS 205 to indicate that the RIS 205 is to transition to an off state. In some cases, the network entity 105-a may utilize encrypted or otherwise secure signaling to transmit the control message, such as higher-layer signaling (e.g., an RRC message).

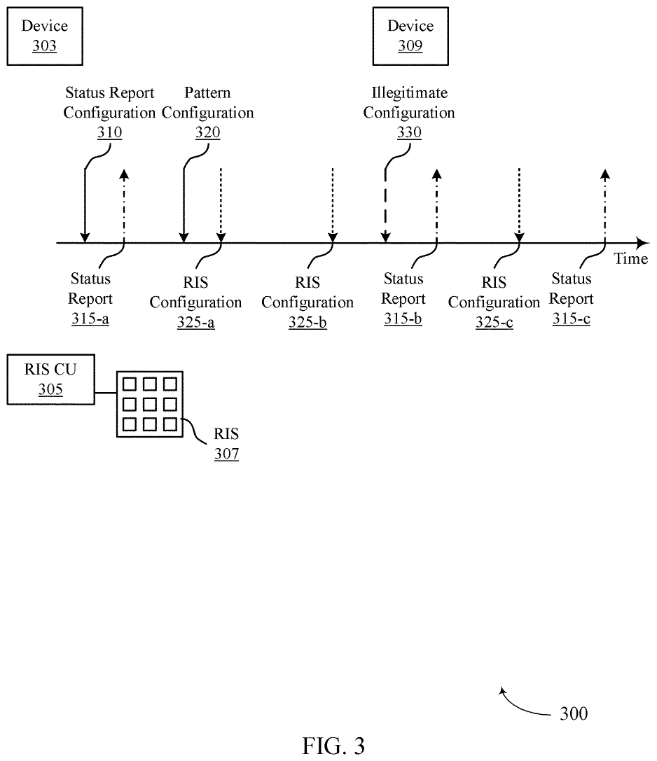

FIG. 3 illustrates an example of a signaling diagram 300 that supports configuration of RIS reporting events in accordance with one or more aspects of the present disclosure. The signaling diagram 300 may implement or be implemented to realize aspects of the wireless communications system 100 or the wireless communications system 200. For example, the signaling diagram 300 may illustrate communications between a device 303 and an RIS CU 305 to configure reporting events at an RIS 307 controlled by the RIS CU 305. The signaling diagram 300 may also include a device 309, which may be an example of a malicious device (e.g., a network entity, a UE) as described with reference to FIG. 2. The RIS CU 305 and the RIS 307 may be examples of corresponding devices described herein. In some aspects, the RIS 307 may operate with the RIS CU 305, or the RIS 307 may operate without the RIS CU 305. That is, the RIS 307 may include functionality and component that are configured to perform the described techniques (e.g., without the RIS CU 305).

The device 303 may include or be an example of a network entity or a UE as described with reference to FIGS. 1 and 2. In the example of FIG. 3, the device 303 may transmit downlink messages to the RIS CU 305 and may receive uplink messages from the RIS CU 305, although other types and combinations of messages may utilize the techniques described herein. For example, if the device 303 is an example of a UE, the device 303 may communicate with the RIS CU 305 via sidelink communications.

As described with reference to FIG. 2, the device 303 may transmit a status report configuration 310 to the RIS CU 305 to indicate a set of parameters for transmitting one or more status reports associated with operations of the RIS 307. The set of parameters may include a quantity of status reports to be transmitted by the RIS CU 305, a status report periodicity, a trigger event for transmitting the status report, a bitmap indicating a mapping between a set of communication configurations (e.g., RIS configurations) and a set of symmetric keys, or a combination thereof. Additionally, or alternatively, the set of parameters may include one or more operating parameters associated with the current operation of the RIS 307 to be included in the status report, such as a current operating state (e.g., an on state, an off state) of the RIS 307, a current configuration of a plurality of reflective elements of the RIS 307 (e.g., a current communication configuration), a quantity of RIS configurations received at the RIS 307 (e.g., within an indicated time period), a list of RIS configurations received at the RIS 307 (e.g., within an indicated time period), or a combination thereof.

In the example of FIG. 3, the RIS CU 305 may be configured (via the status report configuration 310) to transmit a first status report, such as a status report 315-a, to the device 303 indicating a current operating state of the RIS 307. The status report configuration may further indicate that the RIS CU 305 is to transmit additional status reports 315, and that each additional status report is to include a list of RIS configurations (e.g., RIS configurations 325) received at the RIS 307 between two reporting events. For example, a first reporting event of the two reporting events may correspond to transmission of a first status report, such as the status report 315-a, by the RIS CU 305. A second reporting event may correspond to transmission of a second status report, such as the status report 315-b, by the RIS CU 305. Put another way, the RIS CU 305 may be configured to transmit the status report 315-b indicating all RIS configurations received at the RIS CU 305 after transmission of the status report 315-a by the RIS CU 305. Additionally, a third reporting event may correspond to transmission of a third status report, such as a status report 315-c; thus, in the status report 315-c, the RIS CU 305 may indicate a list of RIS configurations received at the RIS CU 305 after receipt of the status report 315-b.

In some aspects, the status report configuration 310 may include a bitmap indicating a mapping between a set of one or more RIS configurations and a set of signatures (e.g., bit sequences), which may be based on or associated with a set of symmetric keys.

The RIS CU 305 may transmit the status report 315-a to the device 303 in accordance with the status report configuration 310. The RIS CU 305 may indicate a current operating state of the RIS 307 in the status report 315-a. For example, the RIS CU 305 may indicate that the RIS 307 is operating in an on state.

The device 303 may transmit a message (e.g., a control message) indicating a pattern configuration 320 to the RIS CU 305 indicating one or more transmission patterns according to which the RIS CU 305 is to transmit subsequent status reports. For example, the pattern configuration 320 may indicate a resource element pattern, an RNTI pattern, and a set of RNTIs associated with the RNTI pattern. The RNTI pattern may include or be indicated by a set of time domain resources corresponding to the set of RNTIs.

The device 303 may transmit a first control message indicating a RIS configuration 325-a to the RIS CU 305. The first control message may further include a first signature associated with the RIS configuration 325-a. The RIS CU 305 may verify that the first control message is a valid message (e.g., originates from an authorized device, such as the device 303) based on a mapping between the first signature and the RIS configuration 325-a indicated by the bitmap (e.g., received in the status report configuration 310). For example, the RIS CU 305 may verify the first control message by confirming that the first signature is associated with the RIS configuration 325-a. The RIS CU 305 may configure the RIS 307 according to the RIS configuration 325-a. The RIS 307 may remain in the RIS configuration 325-a until the RIS CU 305 receives a second control message indicating a RIS configuration 325-b and a second signature, at which time the RIS CU 305 may configure the RIS 307 according to the RIS configuration 325-b. The RIS CU 305 may verify the second control message based on the second signature being associated with the RIS configuration 325-b, e.g., according to the bitmap.

The device 309 may transmit a third control message indicating an illegitimate configuration 330 to the RIS CU 305 in an attempt to control the RIS 307. However, the third control message may lack a signature, or may include an incorrect signature (e.g., a signature that is not included in the bitmap or that is associated with an incorrect RIS configuration). The RIS CU 305 may determine that the third control message is from an unauthorized source based on, for example, a mismatch between the bitmap, an included signature, and the illegitimate configuration 330. In some cases, the RIS CU 305 may be triggered to transmit a status report (such as the status report 315-b) based on receiving the illegitimate configuration 330 (e.g., based on determining that the illegitimate configuration 330 was transmitted by an unauthorized source).

Based on the status report configuration 310, the RIS CU 305 may transmit (e.g., to the device 303) a status report 315-b indicating a list of RIS configurations received at the RIS CU 305 between the first reporting event (e.g., transmission of the status report 315-a) and the second reporting event (e.g., transmission of the status report 315-b). The RIS CU 305 may, for example, include an indication of the RIS configuration 325-a, the RIS configuration 325-b, and the illegitimate configuration 330 in the status report 315-b. The RIS CU 305 may transmit the status report 315-b in accordance with the transmission patterns indicated by the pattern configuration 320. For example, the RIS CU 305 may transmit the status report 315-b over a set of frequency resources in accordance with the resource element pattern. Additionally, the RIS CU 305 may transmit the status report 315-b in a first time domain resource of the set of time domain resources corresponding to the RNTI pattern, where the status report 315-b includes an indication of a first RNTI corresponding to the first time domain resource.

The device 303 may receive the status report 315-b and may verify that the status report 315-b originated at the RIS CU 305 based on the set of frequency resources, the first RNTI, and the first time domain resource aligning with (e.g., matching) the resource element pattern and the RNTI pattern indicated in the pattern configuration 320. The device 303 may compare the indicated list of RIS configurations received at the RIS CU 305 to a list of RIS configurations 325 transmitted by the device 303. Due to the illegitimate configuration 330, the device 303 may identify a mismatch between the indicated list and the list of transmitted RIS configurations, which may enable the device 303 to identify the illegitimate configuration 330 as being unauthorized.

Additionally, or alternatively, the device 303 may compare a current operation of the RIS 307 to the one or more RIS configurations 325 transmitted by the device 303 to determine whether the current operation of the RIS 307 is legitimate. For example, the indicated list of RIS configurations may indicate that the RIS 307 is currently operating according to the illegitimate configuration 330. The device 303 may determine that the illegitimate configuration 330 does not correspond to any of the RIS configurations 325-a or 325-b. Based on the illegitimate configuration 330, the device 303 may determine that the operation of the RIS 307 is also illegitimate. The device 303 may transmit a RIS configuration 325-c to regain control of the RIS CU 305 and to return the RIS 307 to an intended configuration. The RIS CU 305 may configure the RIS 307 according to the RIS configuration 325-c.

The RIS CU 305 may transmit a status report 315-c according to the status report configuration 310 and the pattern configuration 320. The status report 315-c may indicate a list of RIS configurations received at the RIS CU 305 between the second reporting event (e.g., transmission of the status report 315-b) and the third reporting event (e.g., transmission of the status report 315-c). Thus, the status report 315-c may indicate the RIS configuration 325-c. Additionally, in some examples, the RIS CU 305 may include, in the status report 315-c, a third signature corresponding to the RIS configuration 325-c in accordance with the bitmap. For example, the third signature may correspond to a current status of the RIS CU 305 (e.g., an operation status, a RIS configuration).

The RIS CU 305 may transmit the status report 315-c over a second set of frequency resources in accordance with the resource element pattern, and in a second time domain resource of the set of time domain resources corresponding to the RNTI pattern. The RIS CU 305 may include, in the status report 315-c, an indication of a second RNTI corresponding to the second time domain resource.

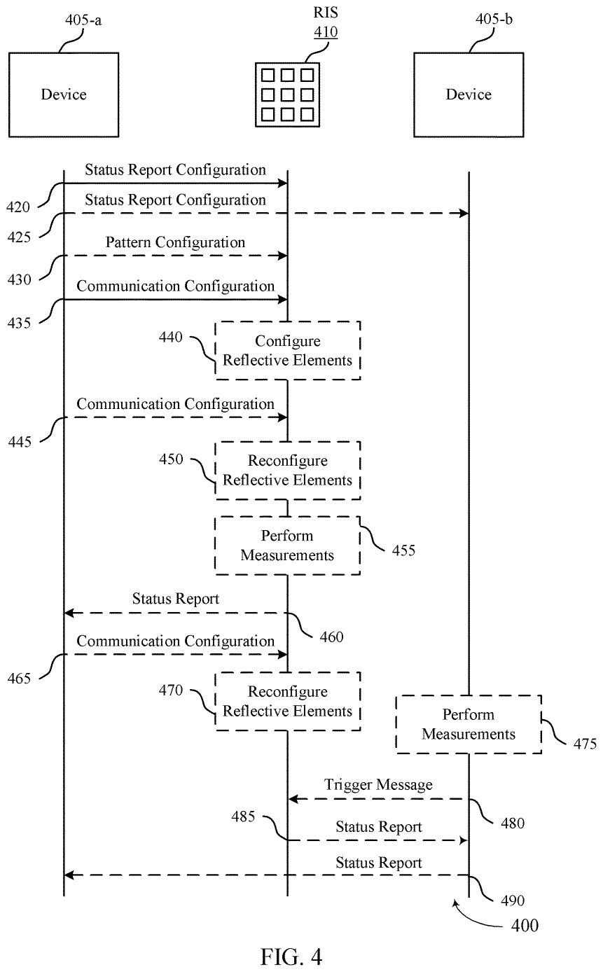

FIG. 4 illustrates an example of a process flow 400 in a system that supports configuration of RIS reporting events in accordance with one or more aspects of the present disclosure. The process flow 400 may implement or be implemented by one or more aspects of devices as described with reference to FIGS. 1 through 3. For example, the process flow may include one or more devices 405 (e.g., a device 405-a, a device 405-b), which may be examples of a network entity or a UE as described with reference to FIGS. 1 through 3. Additionally, the process flow 400 may be implemented by an RIS 410 including a set of reflective elements as described with reference to FIGS. 1 through 3. In the following description of the process flow 400, operations between the devices 405 and the RIS 410 may occur in a different order or at different times than as shown. Some operations may also be omitted from the process flow 400, and other operations may be added to the process flow 400.

At 420, the device 405-a may transmit, and the RIS 410 may receive, a first message indicating a status report configuration that includes a set of parameters for transmitting one or more status reports associated with operations of the RIS 410. The first message may be an example of a PDSCH, a PSSCH, or the like. In some cases, the first message may be an example of a control message, such as a PDCCH, a PSCCH, an RRC message, a MAC-CE, DCI, or the like. In some cases, the set of parameters may include a quantity of status reports to be transmitted by the RIS 410, a status report periodicity for transmitting the one or more status reports, one or more operating parameters associated with the current operation of the RIS 410 to be included in the one or more status reports, a trigger event for transmitting the one or more status reports, a bitmap indicating a mapping between a set of communication configurations and a set of symmetric keys, or a combination thereof.

The one or more operating parameters associated with the current operation of the RIS 410 may include a current operating state of the RIS 410, a current configuration of the set of reflective elements of the RIS 410, a quantity of communication configurations received at the RIS 410, a list of communication configurations received at the RIS 410, or a combination thereof. The indication of the trigger event for transmitting the one or more status reports may include an indication of a change in one or more measurement values associated with reception of one or more messages at the RIS 410. The first message may further indicate the one or more measurement values, which may include an AoA, an RSRP, an RSRQ, an SINR, or a combination thereof.

At 425, the device 405-a may transmit, and the device 405-b may receive, a second message indicating a configuration of a set of status reports to be transmitted by the RIS 410 (e.g., to the device 405-b). The second message may be an example of a PDSCH, a PSSCH, or the like. In some cases, the second message may be an example of a control message, such as a PDCCH, a PSCCH, an RRC message, a MAC-CE, DCI, or the like. In some examples, the second message may indicate a trigger event associated with transmission of a status report by the RIS 410. For example, the second message may indicate one or more measurements to be performed by the device 405-b, where the trigger event consists of a change in one or more measurement values associated with the one or more measurements.

At 430, the device 405-a may transmit, and the RIS 410 may receive, a third message indicating a transmission pattern configuration (e.g., a resource element pattern, an RNTI pattern) for the one or more status reports. For example, the third message may indicate a resource element pattern that includes a randomized resource pattern, a frequency hopping pattern, or a combination thereof. Additionally, or alternatively, the third message may indicate an RNTI pattern and a set of RNTIs associated with the RNTI pattern for the one or more status reports. The indication of the RNTI pattern may include an indication of a set of time domain resources corresponding to the set of indicated RNTIs.

In some cases, the third message may be an example of a PDSCH, a PSSCH, or the like. In other cases, the third message may be an example of a control message, such as a PDCCH, a PSCCH, an RRC message, a MAC-CE, DCI, or the like.

At 435, the device 405-a may transmit, and the RIS 410 may receive, a first control message (e.g., an RRC message, a MAC-CE, DCI) indicating a first communication configuration for the RIS 410. In some examples, the device 405-a may include, in the first control message, a first signature generated by the device 405-a based on a symmetric key (e.g., a private key). The first signature may be associated with the device 405-a and may include a bit sequence. In some examples, the device 405-a may generate the first signature based on the first communication configuration (e.g., based on one or more beam weights or phase configurations of the first communication configuration and associated with one or more reflective elements of the RIS 410). The first signature may map to the first communication configuration in accordance with the bitmap (e.g., indicated in the status report configuration transmitted to the RIS 410 at 420). Based on receiving the first control message, the RIS 410 may verify that the first signature maps to the first communication configuration based on the bitmap.

At 440, the RIS 410 may configure the set of reflective elements in accordance with the first communication configuration for the RIS 410, e.g., based on receiving the first control message.

At 445, the device 405-a may transmit, and the RIS 410 may receive, a second control message (e.g., an RRC message, a MAC-CE, DCI) indicating a second communication configuration for the RIS 410. In some examples, the device 405-a may include a second signature generated by the device 405-a based on the symmetric key. In some examples, the device 405-a may generate the second signature based on the second communication configuration (e.g., based on one or more beam weights or phase configurations of the second communication configuration and associated with one or more reflective elements of the RIS 410). The second signature may map to the second communication configuration in accordance with the bitmap. Based on receiving the second control message, the RIS 410 may verify that the second signature maps to the second communication configuration based on the bitmap.

At 450, the RIS 410 may reconfigure the set of reflective elements in accordance with the second communication configuration for the RIS 410, e.g., based on receiving the second control message.

At 455, the RIS 410 may perform one or more measurements to determine a change in the one or more measurement values associated with the trigger event (e.g., indicated in the status report configuration received at 420). For example, the RIS 410 may perform a first set of one or more measurements (e.g., AoA, RSRP, RSRQ, SINR measurements) associated with reception of the first control message at 435 and a second set of one or more measurements (e.g., AoA, RSRP, RSRQ, SINR measurements) associated with reception of the second control message at 455. The RIS 410 may compare the first set of one or more measurements (e.g., a first set of measurement values associated with the first set of one or more measurements) and the second set of one or more measurements (e.g., a second set of measurement values associated with the second set of one or more measurements) to determine the change in measurement values.

If, at 455, the RIS 410 determines that one or more measurement values have changed, the RIS 410 may be triggered to transmit a first status report to the device 405-a at 460. The first status report may indicate whether a current operation of the RIS 410 corresponds to a valid communication configuration (e.g., a communication configuration transmitted by the device 405-a, such as the first communication configuration or the second communication configuration). For instance, the first status report may indicate that the RIS 410 is currently operating according to the second communication configuration.

The first status report may be transmitted by the RIS 410 and received by the device 405-a in accordance with the status report configuration indicated at 420 and the pattern configuration indicated at 430. For example, the RIS 410 may include, in the first status report, an indication of one or more operating parameters and an indication of a first RNTI. The RIS 410 may transmit the first status report in a frequency domain resource based on the resource element pattern and in a time domain resource based on the RNTI pattern (e.g., corresponding to the first RNTI).

In some examples, the RIS 410 may include an indication of a signature in the first status report. For example, the RIS 410 may include an indication of a signature associated with a current operation (e.g., status or configuration) of the RIS 410. In some cases, the current operation (e.g., status or configuration) of the RIS 410 may correspond to a most recently received communication configuration (e.g., based on the bitmap), such as the communication configuration received at 445. Additionally, or alternatively, if the second control message indicating the communication configuration at 445 included a signature (e.g., the second signature), the RIS 410 may include the second signature in the first status report.

Based on receiving the first status report, the device 405-a may compare the current operation of the RIS 410 (e.g., as indicated by the first status report) to the respective communication configurations transmitted by the device 405-a to determine whether the current operation of the RIS 410 is legitimate. For example, the device 405-a may determine that the current operation of the RIS 410 corresponds to the second communication configuration and is legitimate.

At 465, the device 405-a may transmit, and the RIS 410 may receive, a third control message (e.g., an RRC message, a MAC-CE, DCI) indicating a third communication configuration for the RIS 410. In some examples, the device 405-a may include a third signature generated by the device 405-a based on the symmetric key. In some examples, the device 405-a may generate the third signature based on the third communication configuration (e.g., based on one or more beam weights or phase configurations of the third communication configuration and associated with one or more reflective elements of the RIS 410). The third signature may map to the third communication configuration in accordance with the bitmap. Based on receiving the third control message, the RIS 410 may verify that the third signature maps to the third communication configuration based on the bitmap.

At 470, the RIS 410 may reconfigure the set of reflective elements in accordance with the third communication configuration for the RIS 410, e.g., based on receiving the third control message.

At 475, the device 405-b may perform one or more measurements associated with reception of the third control message at the RIS 410. For example, the device 405-b may perform the one or more measurements to obtain one or more measurement values, such as an AoA, an RSRP, an RSRQ, an SINR, or a combination thereof. The device 405-b may determine that the one or more measurement values have changed, e.g., with respect to one or more corresponding previously-measured values. The change in measurement values determined by the device 405-b may be considered a trigger event.

At 480, based on determining the change in measurement values, the device 405-b may transmit, and the RIS 410 may receive, a fourth message (e.g., a control message, such as an RRC message, an MAC-CE, DCI, or the like) indicating that the RIS 410 is to transmit a status report to the device 405-b. The fourth message may be an example of a trigger message. That is, reception of the fourth message at the RIS 410 may be considered a trigger event at the RIS 410.

At 485, the RIS 410 may transmit, and the device 405-b may receive, in response to the trigger message, a second status report associated with a current operation (e.g., status or configuration) of the RIS 410. The second status report may indicate whether the current operation of the RIS 410 corresponds to one of the communication configurations transmitted by the device 405-a (e.g., the first communication configuration, the second communication configuration, or the third communication configuration). The RIS 410 may transmit the second status report in accordance with the status report configuration received at 420 and, in some cases, the pattern configuration received at 430. In some examples, the RIS 410 may include a signature associated with the current operation (e.g., status or configuration) of the RIS 410.

At 490, the device 405-b may transmit, and the device 405-a may receive, a fifth message indicating the second status report received by the device 405-b from the RIS 410.

Based on receiving the second status report, the device 405-a may compare the current operation of the RIS 410 (e.g., as indicated by the second status report) to the respective communication configurations transmitted by the device 405-a to determine whether the current operation of the RIS 410 is legitimate. For example, the device 405-a may determine that the current operation of the RIS 410 corresponds to the third communication configuration and is legitimate.

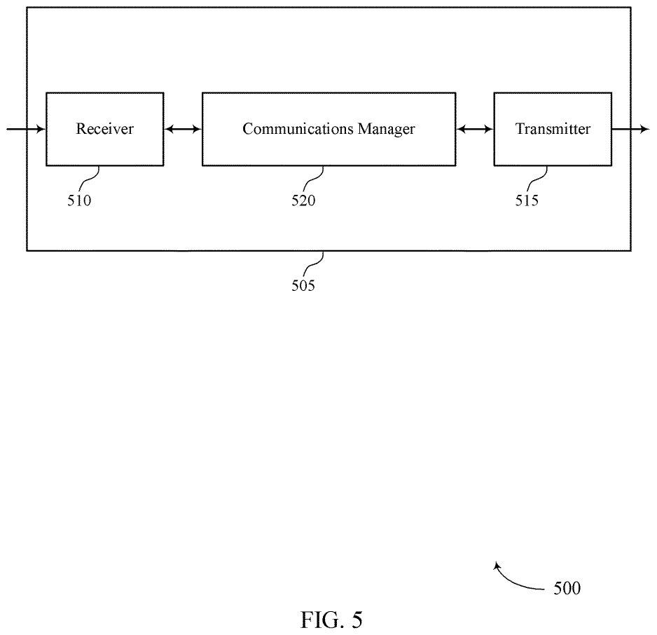

FIG. 5 shows a block diagram 500 of a device 505 that supports configuration of RIS reporting events in accordance with one or more aspects of the present disclosure. The device 505 may be an example of aspects of a network entity 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of configuration of RIS reporting events as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a first device in accordance with examples as disclosed herein. For example, the communications manager 520 may be configured as or otherwise support a means for transmitting, to a second device including a set of multiple reflective elements, a first message indicating a status report configuration, the status report configuration including a set of parameters for transmitting one or more status reports associated with operations of the second device. The communications manager 520 may be configured as or otherwise support a means for transmitting, to the second device, one or more control messages indicating respective communication configurations for the second device. The communications manager 520 may be configured as or otherwise support a means for receiving a status report in accordance with the set of parameters, the status report indicating whether a current operation of the second device corresponds to one of the respective communication configurations.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources, increased communications reliability, and improved security.

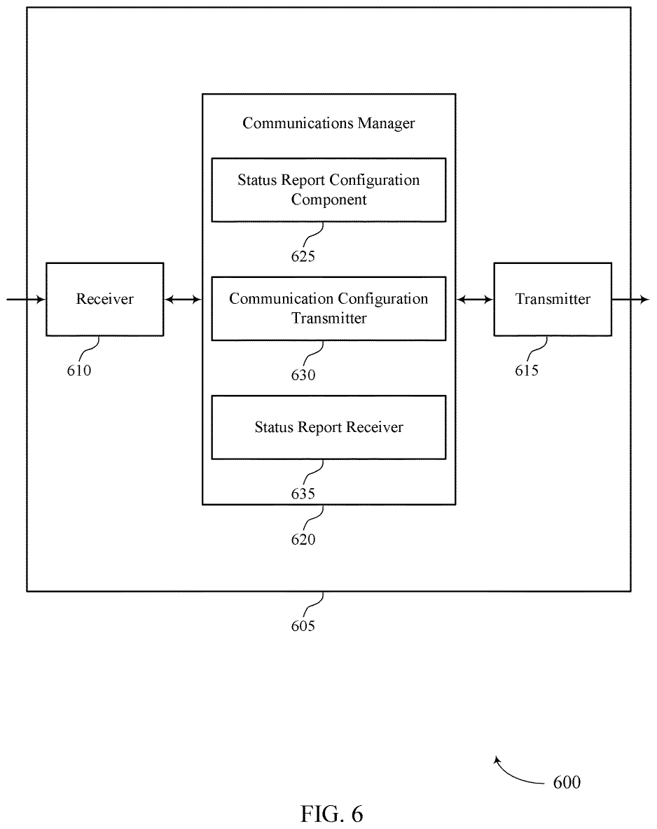

FIG. 6 shows a block diagram 600 of a device 605 that supports configuration of RIS reporting events in accordance with one or more aspects of the present disclosure. The device 605 may be an example of aspects of a device 505 or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of configuration of RIS reporting events as described herein. For example, the communications manager 620 may include a status report configuration component 625, a communication configuration transmitter 630, a status report receiver 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first device in accordance with examples as disclosed herein. The status report configuration component 625 may be configured as or otherwise support a means for transmitting, to a second device including a set of multiple reflective elements, a first message indicating a status report configuration, the status report configuration including a set of parameters for transmitting one or more status reports associated with operations of the second device. The communication configuration transmitter 630 may be configured as or otherwise support a means for transmitting, to the second device, one or more control messages indicating respective communication configurations for the second device. The status report receiver 635 may be configured as or otherwise support a means for receiving a status report in accordance with the set of parameters, the status report indicating whether a current operation of the second device corresponds to one of the respective communication configurations.

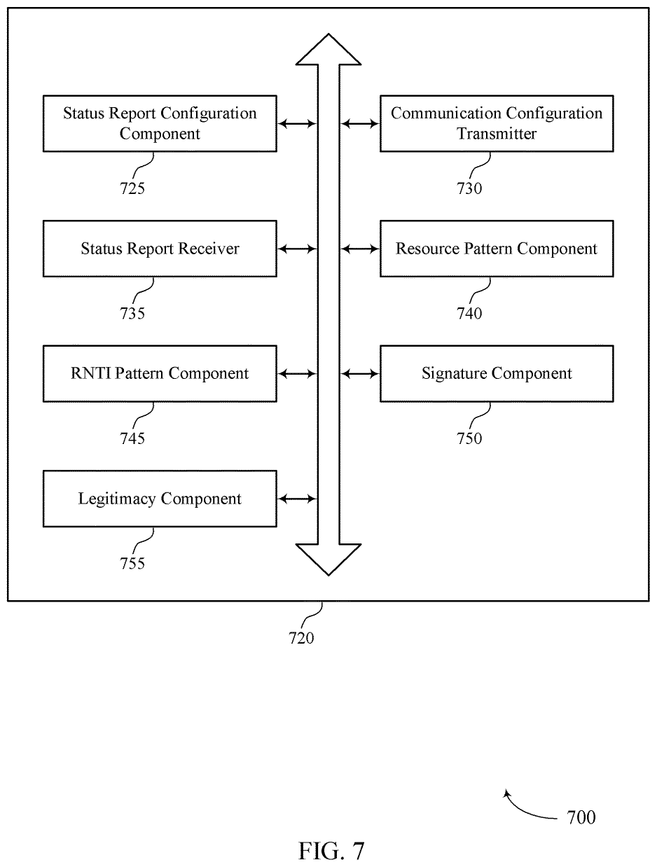

FIG. 7 shows a block diagram 700 of a communications manager 720 that supports configuration of RIS reporting events in accordance with one or more aspects of the present disclosure. The communications manager 720 may be an example of aspects of a communications manager 520, a communications manager 620, or both, as described herein. The communications manager 720, or various components thereof, may be an example of means for performing various aspects of configuration of RIS reporting events as described herein. For example, the communications manager 720 may include a status report configuration component 725, a communication configuration transmitter 730, a status report receiver 735, a resource pattern component 740, an RNTI pattern component 745, a signature component 750, a legitimacy component 755, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications at a first device in accordance with examples as disclosed herein. The status report configuration component 725 may be configured as or otherwise support a means for transmitting, to a second device including a set of multiple reflective elements, a first message indicating a status report configuration, the status report configuration including a set of parameters for transmitting one or more status reports associated with operations of the second device. The communication configuration transmitter 730 may be configured as or otherwise support a means for transmitting, to the second device, one or more control messages indicating respective communication configurations for the second device. The status report receiver 735 may be configured as or otherwise support a means for receiving a status report in accordance with the set of parameters, the status report indicating whether a current operation of the second device corresponds to one of the respective communication configurations.

In some examples, the status report configuration component 725 may be configured as or otherwise support a means for transmitting, to a third device different from the second device, a second message indicating a configuration of a set of status reports to be transmitted by the second device, where the status report is received from the third device based on the configuration of the set of status reports.

In some examples, to support receiving the status report, the status report receiver 735 may be configured as or otherwise support a means for receiving the status report from the second device based on one or more trigger events and the status report configuration. In some examples, the set of parameters includes a quantity of status reports to be transmitted, a status report periodicity, one or more operating parameters associated with the current operation of the second device to be included in the status report, a trigger event for the status report, a bitmap indicating a mapping between a set of communication configurations and a set of symmetric keys, or a combination thereof.

In some examples, the one or more operating parameters include a current operating state of the second device, a current configuration of the set of multiple reflective elements of the second device, a quantity of communication configurations received at the second device, a list of communication configurations received at the second device, or a combination thereof. In some examples, the trigger event includes a change in one or more measurement values associated with reception of the one or more control messages at the second device, the one or more measurement values including an AoA, an RSRP, an RSRQ, an SINR, or a combination thereof.

In some examples, the resource pattern component 740 may be configured as or otherwise support a means for transmitting, to the second device, a third message indicating a resource pattern for the one or more status reports, the resource pattern including a randomized pattern, a frequency hopping pattern, or a combination thereof, where the status report is received in accordance with the resource pattern.

In some examples, the RNTI pattern component 745 may be configured as or otherwise support a means for transmitting, to the second device, a third message indicating a set of radio network temporary identifiers associated with a radio network temporary identifier pattern for the one or more status reports, the radio network temporary identifier pattern including a set of time domain resources corresponding to the set of radio network temporary identifiers, where the status report includes a radio network temporary identifier in accordance with the radio network temporary identifier pattern.

In some examples, the signature component 750 may be configured as or otherwise support a means for generating a signature associated with the first device based on a symmetric key, the signature including a bit sequence, where the first message includes the signature. In some examples, the status report further indicates a signature associated with the current operation of the second device based on a bitmap between a one or more signatures and a current status of the second device.

In some examples, the legitimacy component 755 may be configured as or otherwise support a means for comparing, based on the status report, the current operation of the second device to the respective communication configurations to determine whether the current operation of the second device is legitimate.

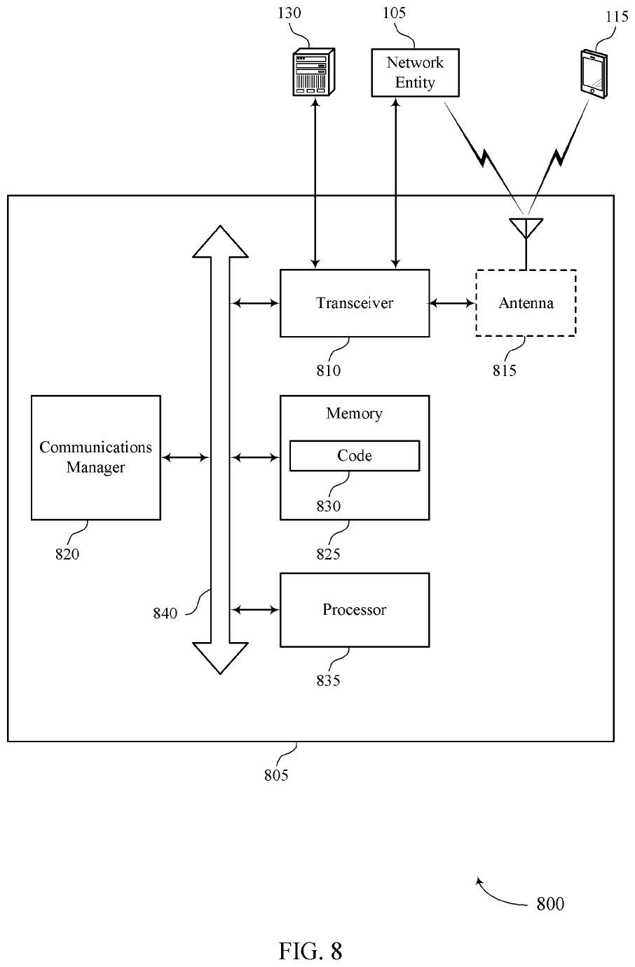

FIG. 8 shows a diagram of a system 800 including a device 805 that supports configuration of RIS reporting events in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, a memory 825, code 830, and a processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or memory components (for example, the processor 835, or the memory 825, or both), may be included in a chip or chip assembly that is installed in the device 805. In some examples, the transceiver may be operable to support communications via one or more communications links (e.g., a communication link 125, a backhaul communication link 120, a midhaul communication link 162, a fronthaul communication link 168).

The memory 825 may include RAM and ROM. The memory 825 may store computer-readable, computer-executable code 830 including instructions that, when executed by the processor 835, cause the device 805 to perform various functions described herein. The code 830 may be stored in a non-transitory computer-readable medium such as system memory or another type of memory. In some cases, the code 830 may not be directly executable by the processor 835 but may cause a computer (e.g., when compiled and executed) to perform functions described herein. In some cases, the memory 825 may contain, among other things, a BIOS which may control basic hardware or software operation such as the interaction with peripheral components or devices.

The processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 835 may be configured to operate a memory array using a memory controller. In some other cases, a memory controller may be integrated into the processor 835. The processor 835 may be configured to execute computer-readable instructions stored in a memory (e.g., the memory 825) to cause the device 805 to perform various functions (e.g., functions or tasks supporting configuration of RIS reporting events). For example, the device 805 or a component of the device 805 may include a processor 835 and memory 825 coupled with the processor 835, the processor 835 and memory 825 configured to perform various functions described herein. The processor 835 may be an example of a cloud-computing platform (e.g., one or more physical nodes and supporting software such as operating systems, virtual machines, or container instances) that may host the functions (e.g., by executing code 830) to perform the functions of the device 805. The processor 835 may be any one or more suitable processors capable of executing scripts or instructions of one or more software programs stored in the device 805 (such as within the memory 825). In some implementations, the processor 835 may be a component of a processing system. A processing system may generally refer to a system or series of machines or components that receives inputs and processes the inputs to produce a set of outputs (which may be passed to other systems or components of, for example, the device 805). For example, a processing system of the device 805 may refer to a system including the various other components or subcomponents of the device 805, such as the processor 835, or the transceiver 810, or the communications manager 820, or other components or combinations of components of the device 805. The processing system of the device 805 may interface with other components of the device 805, and may process information received from other components (such as inputs or signals) or output information to other components. For example, a chip or modem of the device 805 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 805 may transmit information output from the chip or modem. Additionally, or alternatively, in some implementations, the one or more interfaces may refer to an interface between the processing system of the chip or modem and a receiver, such that the device 805 may obtain information or signal inputs, and the information may be passed to the processing system. A person having ordinary skill in the art will readily recognize that a first interface also may obtain information or signal inputs, and a second interface also may output information or signal outputs.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the memory 825, the code 830, and the processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communications at a first device in accordance with examples as disclosed herein. For example, the communications manager 820 may be configured as or otherwise support a means for transmitting, to a second device including a set of multiple reflective elements, a first message indicating a status report configuration, the status report configuration including a set of parameters for transmitting one or more status reports associated with operations of the second device. The communications manager 820 may be configured as or otherwise support a means for transmitting, to the second device, one or more control messages indicating respective communication configurations for the second device. The communications manager 820 may be configured as or otherwise support a means for receiving a status report in accordance with the set of parameters, the status report indicating whether a current operation of the second device corresponds to one of the respective communication configurations.

By including or configuring the communications manager 820 in accordance with examples as described herein, the device 805 may support techniques for improved communication reliability, reduced latency, improved coordination between devices, increased security, and longer battery life.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, the processor 835, the memory 825, the code 830, or any combination thereof. For example, the code 830 may include instructions executable by the processor 835 to cause the device 805 to perform various aspects of configuration of RIS reporting events as described herein, or the processor 835 and the memory 825 may be otherwise configured to perform or support such operations.

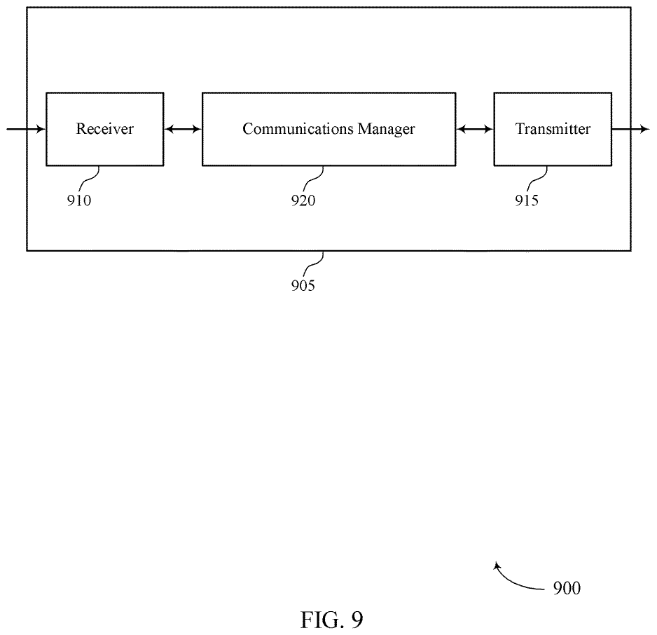

FIG. 9 shows a block diagram 900 of a device 905 that supports configuration of RIS reporting events in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to configuration of RIS reporting events). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to configuration of RIS reporting events). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of configuration of RIS reporting events as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first device in accordance with examples as disclosed herein. For example, the communications manager 920 may be configured as or otherwise support a means for transmitting, to a second device including a set of multiple reflective elements, a first message indicating a status report configuration, the status report configuration including a set of parameters for transmitting one or more status reports associated with operations of the second device. The communications manager 920 may be configured as or otherwise support a means for transmitting, to the second device, one or more control messages indicating respective communication configurations for the second device. The communications manager 920 may be configured as or otherwise support a means for receiving a status report in accordance with the set of parameters, the status report indicating whether a current operation of the second device corresponds to one of the respective communication configurations.

Additionally, or alternatively, the communications manager 920 may support wireless communications at a UE in accordance with examples as disclosed herein. For example, the communications manager 920 may be configured as or otherwise support a means for communicating with a first device via a second device, the second device including a set of multiple reflective elements. The communications manager 920 may be configured as or otherwise support a means for receiving, from the second device, a status report associated with current operation of the second device, where the status report is received in response to a trigger event. The communications manager 920 may be configured as or otherwise support a means for transmitting, to the first device, a first message indicating the status report received from the second device.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources.

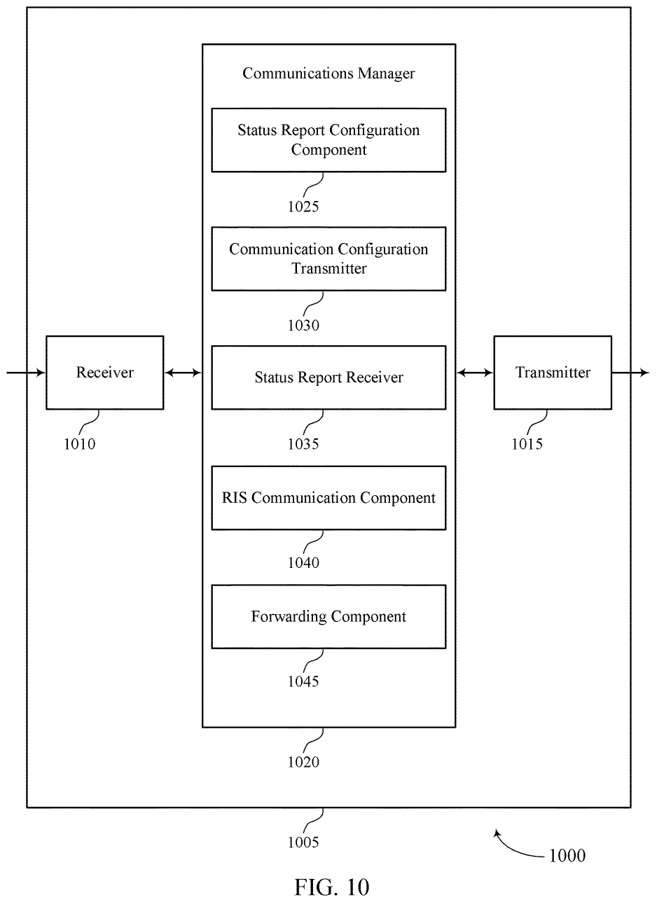

FIG. 10 shows a block diagram 1000 of a device 1005 that supports configuration of RIS reporting events in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to configuration of RIS reporting events). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to configuration of RIS reporting events). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of configuration of RIS reporting events as described herein. For example, the communications manager 1020 may include a status report configuration component 1025, a communication configuration transmitter 1030, a status report receiver 1035, a RIS communication component 1040, a forwarding component 1045, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first device in accordance with examples as disclosed herein. The status report configuration component 1025 may be configured as or otherwise support a means for transmitting, to a second device including a set of multiple reflective elements, a first message indicating a status report configuration, the status report configuration including a set of parameters for transmitting one or more status reports associated with operations of the second device. The communication configuration transmitter 1030 may be configured as or otherwise support a means for transmitting, to the second device, one or more control messages indicating respective communication configurations for the second device. The status report receiver 1035 may be configured as or otherwise support a means for receiving a status report in accordance with the set of parameters, the status report indicating whether a current operation of the second device corresponds to one of the respective communication configurations.

Additionally, or alternatively, the communications manager 1020 may support wireless communications at a UE in accordance with examples as disclosed herein. The RIS communication component 1040 may be configured as or otherwise support a means for communicating with a first device via a second device, the second device including a set of multiple reflective elements. The status report receiver 1035 may be configured as or otherwise support a means for receiving, from the second device, a status report associated with current operation of the second device, where the status report is received in response to a trigger event. The forwarding component 1045 may be configured as or otherwise support a means for transmitting, to the first device, a first message indicating the status report received from the second device.

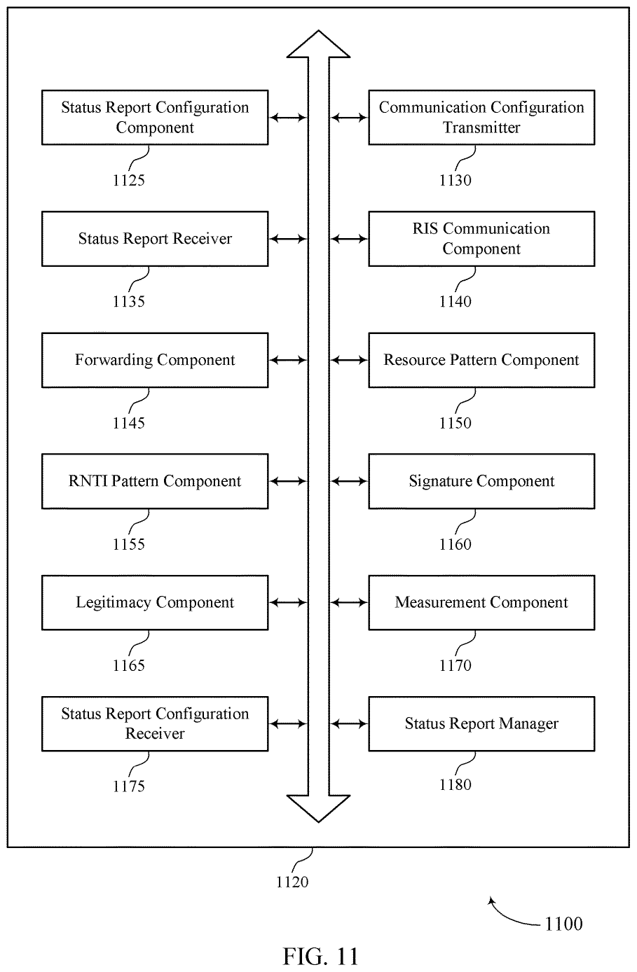

FIG. 11 shows a block diagram 1100 of a communications manager 1120 that supports configuration of RIS reporting events in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of configuration of RIS reporting events as described herein. For example, the communications manager 1120 may include a status report configuration component 1125, a communication configuration transmitter 1130, a status report receiver 1135, a RIS communication component 1140, a forwarding component 1145, a resource pattern component 1150, an RNTI pattern component 1155, a signature component 1160, a legitimacy component 1165, a measurement component 1170, a status report configuration receiver 1175, a status report manager 1180, or any combination thereof. Each of these components may communicate, directly or indirectly, with one another (e.g., via one or more buses).

The communications manager 1120 may support wireless communications at a first device in accordance with examples as disclosed herein. The status report configuration component 1125 may be configured as or otherwise support a means for transmitting, to a second device including a set of multiple reflective elements, a first message indicating a status report configuration, the status report configuration including a set of parameters for transmitting one or more status reports associated with operations of the second device. The communication configuration transmitter 1130 may be configured as or otherwise support a means for transmitting, to the second device, one or more control messages indicating respective communication configurations for the second device. The status report receiver 1135 may be configured as or otherwise support a means for receiving a status report in accordance with the set of parameters, the status report indicating whether a current operation of the second device corresponds to one of the respective communication configurations.

In some examples, the status report configuration component 1125 may be configured as or otherwise support a means for transmitting, to a third device different from the second device, a second message indicating a configuration of a set of status reports to be transmitted by the second device, where the status report is received from the third device based on the configuration of the set of status reports.

In some examples, to support receiving the status report, the status report receiver 1135 may be configured as or otherwise support a means for receiving the status report from the second device based on one or more trigger events and the status report configuration.

In some examples, the set of parameters includes a quantity of status reports to be transmitted, a status report periodicity, one or more operating parameters associated with the current operation of the second device to be included in the status report, a trigger event for the status report, a bitmap indicating a mapping between a set of communication configurations and a set of symmetric keys, or a combination thereof.

In some examples, the one or more operating parameters include a current operating state of the second device, a current configuration of the set of multiple reflective elements of the second device, a quantity of communication configurations received at the second device, a list of communication configurations received at the second device, or a combination thereof.

In some examples, the trigger event includes a change in one or more measurement values associated with reception of the one or more control messages at the second device, the one or more measurement values including an AoA, an RSRP, an RSRQ, an SINR, or a combination thereof.

In some examples, the resource pattern component 1150 may be configured as or otherwise support a means for transmitting, to the second device, a third message indicating a resource pattern for the one or more status reports, the resource pattern including a randomized pattern, a frequency hopping pattern, or a combination thereof, where the status report is received in accordance with the resource pattern.

In some examples, the RNTI pattern component 1155 may be configured as or otherwise support a means for transmitting, to the second device, a third message indicating a set of radio network temporary identifiers associated with a radio network temporary identifier pattern for the one or more status reports, the radio network temporary identifier pattern including a set of time domain resources corresponding to the set of radio network temporary identifiers, where the status report includes a radio network temporary identifier in accordance with the radio network temporary identifier pattern.

In some examples, the signature component 1160 may be configured as or otherwise support a means for generating a signature associated with the first device based on a symmetric key, the signature including a bit sequence, where the first message includes the signature.

In some examples, the status report further indicates a signature associated with the current operation of the second device based on a bitmap between a one or more signatures and a current status of the second device.

In some examples, the legitimacy component 1165 may be configured as or otherwise support a means for comparing, based on the status report, the current operation of the second device to the respective communication configurations to determine whether the current operation of the second device is legitimate.

Additionally, or alternatively, the communications manager 1120 may support wireless communications at a UE in accordance with examples as disclosed herein. The RIS communication component 1140 may be configured as or otherwise support a means for communicating with a first device via a second device, the second device including a set of multiple reflective elements. In some examples, the status report receiver 1135 may be configured as or otherwise support a means for receiving, from the second device, a status report associated with current operation of the second device, where the status report is received in response to a trigger event. The forwarding component 1145 may be configured as or otherwise support a means for transmitting, to the first device, a first message indicating the status report received from the second device.

In some examples, the status report manager 1180 may be configured as or otherwise support a means for transmitting, to the second device, a second message indicating that the second device is to transmit the status report to the UE, where transmitting the second message includes the trigger event, and where the status report is received in response to the second message.

In some examples, the trigger event includes a change in one or more measurement values associated with reception of one or more control messages, the one or more measurement values including an AoA, an RSRP, an RSRQ, an SINR, or any combination thereof.

In some examples, the measurement component 1170 may be configured as or otherwise support a means for performing one or more measurements to determine the change in the measurement value based on the one or more control messages.

In some examples, the status report configuration receiver 1175 may be configured as or otherwise support a means for receiving, from the first device, a third message indicating a configuration of a set of status reports to be transmitted by the second device, where receiving the status report is based on the configuration of the set of status reports.

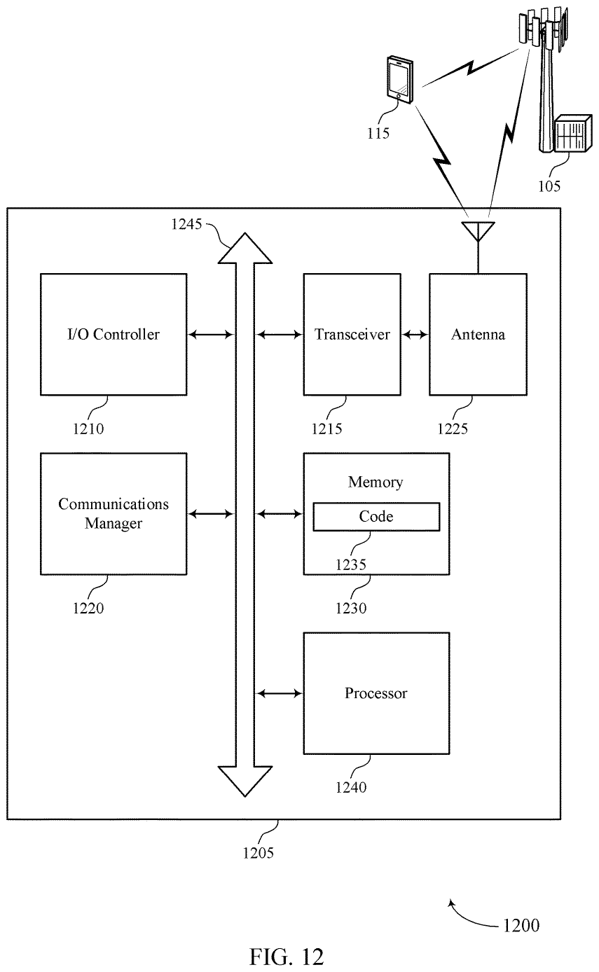

FIG. 12 shows a diagram of a system 1200 including a device 1205 that supports configuration of RIS reporting events in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting configuration of RIS reporting events). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a first device in accordance with examples as disclosed herein. For example, the communications manager 1220 may be configured as or otherwise support a means for transmitting, to a second device including a set of multiple reflective elements, a first message indicating a status report configuration, the status report configuration including a set of parameters for transmitting one or more status reports associated with operations of the second device. The communications manager 1220 may be configured as or otherwise support a means for transmitting, to the second device, one or more control messages indicating respective communication configurations for the second device. The communications manager 1220 may be configured as or otherwise support a means for receiving a status report in accordance with the set of parameters, the status report indicating whether a current operation of the second device corresponds to one of the respective communication configurations.

Additionally, or alternatively, the communications manager 1220 may support wireless communications at a UE in accordance with examples as disclosed herein. For example, the communications manager 1220 may be configured as or otherwise support a means for communicating with a first device via a second device, the second device including a set of multiple reflective elements. The communications manager 1220 may be configured as or otherwise support a means for receiving, from the second device, a status report associated with current operation of the second device, where the status report is received in response to a trigger event. The communications manager 1220 may be configured as or otherwise support a means for transmitting, to the first device, a first message indicating the status report received from the second device.

By including or configuring the communications manager 1220 in accordance with examples as described herein, the device 1205 may support techniques for improved communication reliability, reduced latency, reduced power consumption, more efficient utilization of communication resources, and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of configuration of RIS reporting events as described herein, or the processor 1240 and the memory 1230 may be otherwise configured to perform or support such operations.

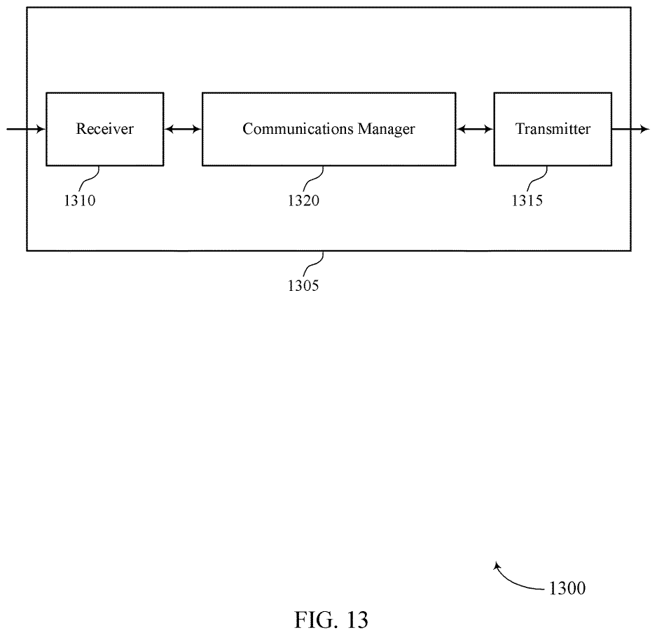

FIG. 13 shows a block diagram 1300 of a device 1305 that supports configuration of RIS reporting events in accordance with one or more aspects of the present disclosure. The device 1305 may be an example of aspects of a device comprising a plurality of reflective elements, such as an RIS, an RIS controller, or the like, as described herein. In some examples, the device 1305 may be an example of aspects of a UE 115 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to configuration of RIS reporting events). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to configuration of RIS reporting events). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of configuration of RIS reporting events as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a second device including a set of multiple reflective elements in accordance with examples as disclosed herein. For example, the communications manager 1320 may be configured as or otherwise support a means for receiving, from a first device, a first message indicating a status report configuration, the status report configuration including a set of parameters for transmitting one or more status reports associated with operations of the second device. The communications manager 1320 may be configured as or otherwise support a means for transmitting, based on a trigger event, a status report in accordance with the set of parameters, the status report associated with current operation of the second device.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced processing, reduced power consumption, and more efficient utilization of communication resources.

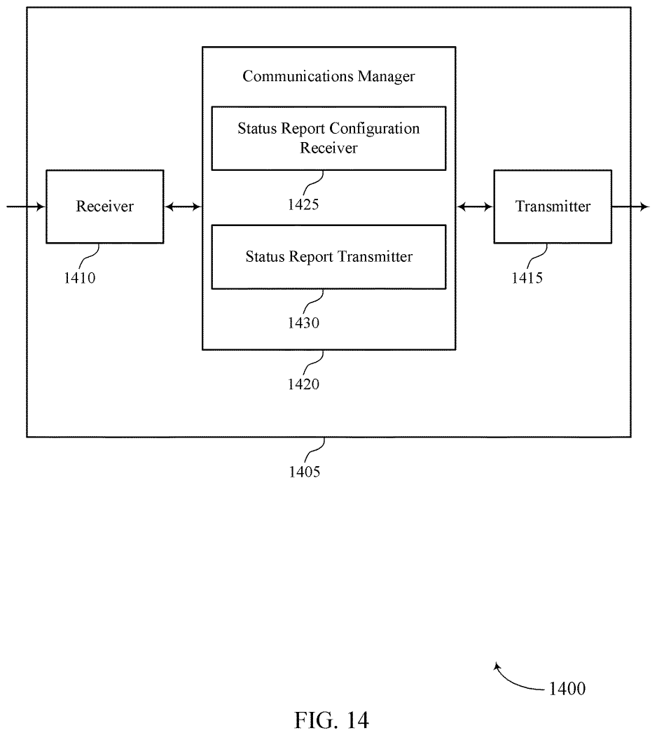

FIG. 14 shows a block diagram 1400 of a device 1405 that supports configuration of RIS reporting events in accordance with one or more aspects of the present disclosure. The device 1405 may be an example of aspects of a device 1305, a device comprising a plurality of reflective elements (e.g., an RIS, an RIS controller), or a UE 115 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to configuration of RIS reporting events). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to configuration of RIS reporting events). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of configuration of RIS reporting events as described herein. For example, the communications manager 1420 may include a status report configuration receiver 1425, a status report transmitter 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a second device including a set of multiple reflective elements in accordance with examples as disclosed herein. The status report configuration receiver 1425 may be configured as or otherwise support a means for receiving, from a first device, a first message indicating a status report configuration, the status report configuration including a set of parameters for transmitting one or more status reports associated with operations of the second device. The status report transmitter 1430 may be configured as or otherwise support a means for transmitting, based on a trigger event, a status report in accordance with the set of parameters, the status report associated with current operation of the second device.

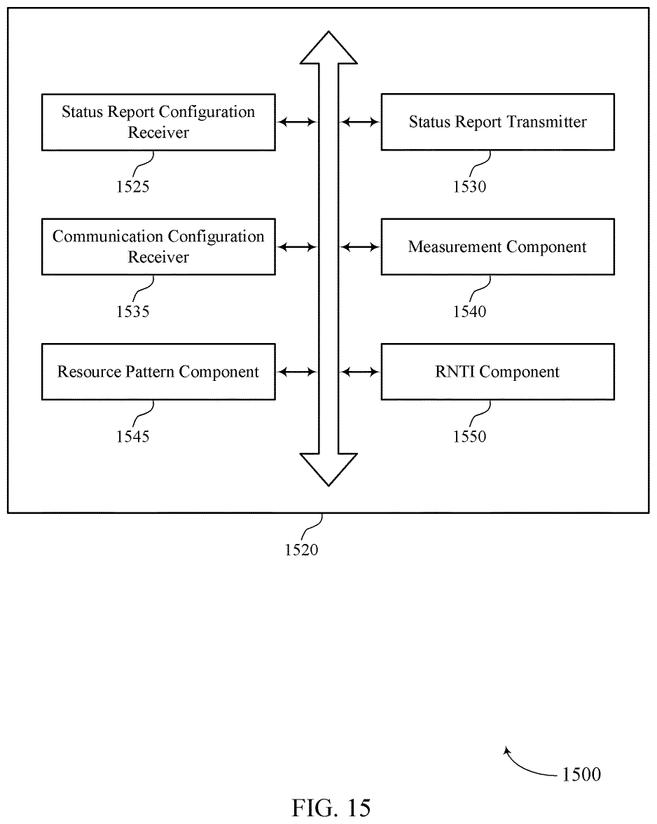

FIG. 15 shows a block diagram 1500 of a communications manager 1520 that supports configuration of RIS reporting events in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of configuration of RIS reporting events as described herein. For example, the communications manager 1520 may include a status report configuration receiver 1525, a status report transmitter 1530, a communication configuration receiver 1535, a measurement component 1540, a resource pattern component 1545, an RNTI component 1550, or any combination thereof. Each of these components may communicate, directly or indirectly, with one another (e.g., via one or more buses).

The communications manager 1520 may support wireless communications at a second device including a set of multiple reflective elements in accordance with examples as disclosed herein. The status report configuration receiver 1525 may be configured as or otherwise support a means for receiving, from a first device, a first message indicating a status report configuration, the status report configuration including a set of parameters for transmitting one or more status reports associated with operations of the second device. The status report transmitter 1530 may be configured as or otherwise support a means for transmitting, based on a trigger event, a status report in accordance with the set of parameters, the status report associated with current operation of the second device.

In some examples, the communication configuration receiver 1535 may be configured as or otherwise support a means for receiving, from the first device, one or more control messages indicating respective communication configurations for the second device, where the status report indicates whether the current operation of the second device corresponds to one of the respective communication configurations.

In some examples, the set of parameters includes a quantity of status reports, a status report periodicity, one or more operating parameters associated with the operations of the second device, an indication of the trigger event for the status report, a bitmap indicating a mapping between a set of communication configurations and a set of symmetric keys, or a combination thereof.

In some examples, the one or more operating parameters include a current operating state of the second device, a current configuration of the set of multiple reflective elements of the second device, a quantity of one or more communication configurations received at the second device, a list of communication configurations received at the second device, or a combination thereof.

In some examples, the trigger event includes a change in one or more measurement values associated with reception of one or more control messages at the second device, the one or more measurement values including an AoA, an RSRP, an RSRQ, an SINR, or a combination thereof.

In some examples, the measurement component 1540 may be configured as or otherwise support a means for performing one or more measurements to determine the change in the one or more measurement values based on receiving the one or more control messages.

In some examples, the resource pattern component 1545 may be configured as or otherwise support a means for receiving a second message indicating a resource pattern for the one or more status reports, the resource pattern including a randomized pattern, a frequency hopping pattern, or a combination thereof, where the status report is transmitted in accordance with the resource pattern.

In some examples, the RNTI component 1550 may be configured as or otherwise support a means for receiving a second message indicating a set of radio network temporary identifiers associated with a radio network temporary identifier pattern for the one or more status reports, the radio network temporary identifier pattern including a set of time domain resources corresponding to the set of radio network temporary identifiers, where the status report includes a radio network temporary identifier in accordance with the radio network temporary identifier pattern.

In some examples, the first message further indicates a signature associated with the first device and based on a symmetric key. In some examples, the status report further indicates a signature associated with the current operation of the second device based on a bitmap between a one or more signatures and a current status of the second device.

In some examples, to support transmitting the status report, the status report transmitter 1530 may be configured as or otherwise support a means for transmitting the status report to a third device different from the first device based on the status report configuration.

In some examples, the status report transmitter 1530 may be configured as or otherwise support a means for receiving a third message from the third device, where receiving the third message includes the trigger event, and where transmitting the status report to the third device is in response to receiving the third message.

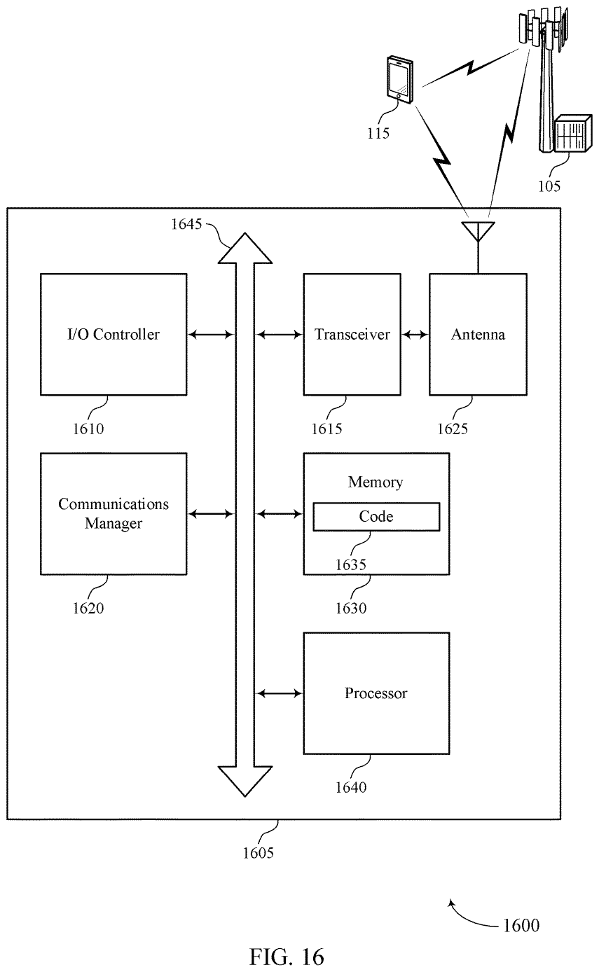

FIG. 16 shows a diagram of a system 1600 including a device 1605 that supports configuration of RIS reporting events in accordance with one or more aspects of the present disclosure. The device 1605 may be an example of or include the components of a device 1305, a device 1405, a device comprising a plurality of reflective elements (e.g., an RIS, an RIS controller), or a UE 115 as described herein. The device 1605 may communicate (e.g., wirelessly) with one or more network entities 105, one or more UEs 115, or any combination thereof. The device 1605 may include components for bi-directional voice and data communications including components for transmitting and receiving communications, such as a communications manager 1620, an input/output (I/O) controller 1610, a transceiver 1615, an antenna 1625, a memory 1630, code 1635, and a processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally, or alternatively, the I/O controller 1610 may represent or interact with a modem, a keyboard, a mouse, a touchscreen, or a similar device. In some cases, the I/O controller 1610 may be implemented as part of a processor, such as the processor 1640. In some cases, a user may interact with the device 1605 via the I/O controller 1610 or via hardware components controlled by the I/O controller 1610.

In some cases, the device 1605 may include a single antenna 1625. However, in some other cases, the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include RAM and ROM. The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a basic I/O system (BIOS) which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting configuration of RIS reporting events). For example, the device 1605 or a component of the device 1605 may include a processor 1640 and memory 1630 coupled with or to the processor 1640, the processor 1640 and memory 1630 configured to perform various functions described herein.

The communications manager 1620 may support wireless communications at a second device including a set of multiple reflective elements in accordance with examples as disclosed herein. For example, the communications manager 1620 may be configured as or otherwise support a means for receiving, from a first device, a first message indicating a status report configuration, the status report configuration including a set of parameters for transmitting one or more status reports associated with operations of the second device. The communications manager 1620 may be configured as or otherwise support a means for transmitting, based on a trigger event, a status report in accordance with the set of parameters, the status report associated with current operation of the second device.

By including or configuring the communications manager 1620 in accordance with examples as described herein, the device 1605 may support techniques for improved communication reliability, reduced latency, reduced power consumption, more efficient utilization of communication resources, and improved coordination between devices.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of configuration of RIS reporting events as described herein, or the processor 1640 and the memory 1630 may be otherwise configured to perform or support such operations.

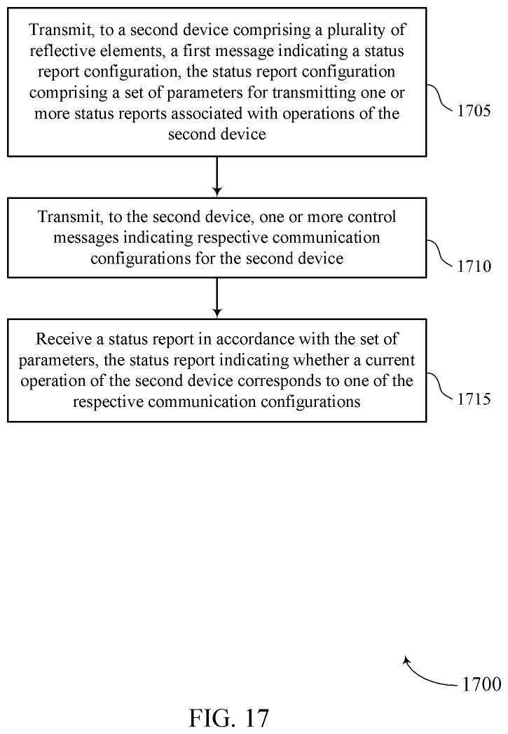

FIG. 17 shows a flowchart illustrating a method 1700 that supports configuration of RIS reporting events in accordance with one or more aspects of the present disclosure. The operations of the method 1700 may be implemented by a network entity or a UE or its components as described herein. For example, the operations of the method 1700 may be performed by a network entity as described with reference to FIGS. 1 through 8 or a UE 115 as described with reference to FIGS. 1 through 4 and 9 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1705, the method may include transmitting, to a second device including a set of multiple reflective elements, a first message indicating a status report configuration, the status report configuration including a set of parameters for transmitting one or more status reports associated with operations of the second device. The operations of 1705 may be performed in accordance with examples as disclosed herein. In some examples, aspects of the operations of 1705 may be performed by a status report configuration component 725 or a status report configuration component 1125 as described with reference to FIGS. 7 and 11.

At 1710, the method may include transmitting, to the second device, one or more control messages indicating respective communication configurations for the second device. The operations of 1710 may be performed in accordance with examples as disclosed herein. In some examples, aspects of the operations of 1710 may be performed by a communication configuration transmitter 730 or a communication configuration transmitter 1130 as described with reference to FIGS. 7 and 11.

At 1715, the method may include receiving a status report in accordance with the set of parameters, the status report indicating whether a current operation of the second device corresponds to one of the respective communication configurations. The operations of 1715 may be performed in accordance with examples as disclosed herein. In some examples, aspects of the operations of 1715 may be performed by a status report receiver 735 or a status report receiver 1135 as described with reference to FIGS. 7 and 11.

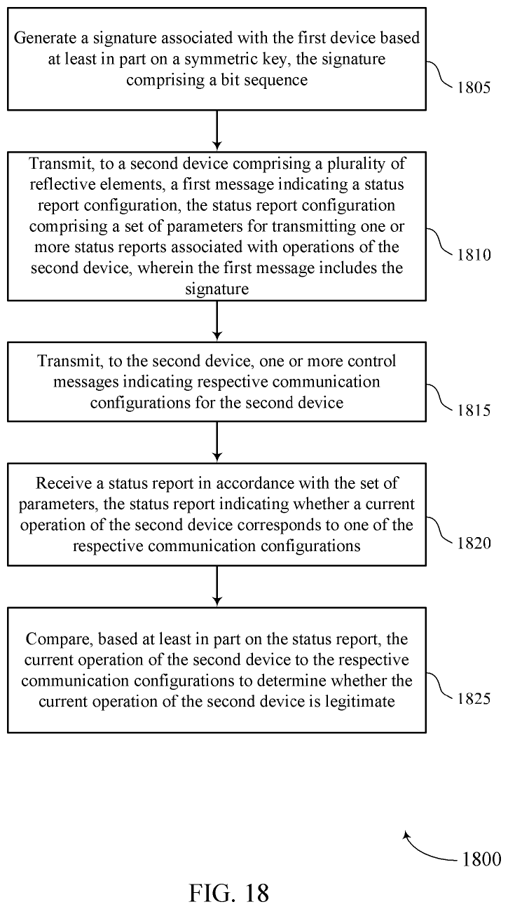

FIG. 18 shows a flowchart illustrating a method 1800 that supports configuration of RIS reporting events in accordance with one or more aspects of the present disclosure. The operations of the method 1800 may be implemented by a network entity or a UE or its components as described herein. For example, the operations of the method 1800 may be performed by a network entity as described with reference to FIGS. 1 through 8 or a UE 115 as described with reference to FIGS. 1 through 4 and 9 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1805, the method may include generating a signature associated with the first device based on a symmetric key, the signature including a bit sequence. The operations of 1805 may be performed in accordance with examples as disclosed herein. In some examples, aspects of the operations of 1805 may be performed by a signature component 750 or a signature component 1160 as described with reference to FIGS. 7 and 11.

At 1810, the method may include transmitting, to a second device including a set of multiple reflective elements, a first message indicating a status report configuration, the status report configuration including a set of parameters for transmitting one or more status reports associated with operations of the second device, where the first message includes the signature. The operations of 1810 may be performed in accordance with examples as disclosed herein. In some examples, aspects of the operations of 1810 may be performed by a status report configuration component 725 or a status report configuration component 1125 as described with reference to FIGS. 7 and 11.

At 1815, the method may include transmitting, to the second device, one or more control messages indicating respective communication configurations for the second device. The operations of 1815 may be performed in accordance with examples as disclosed herein. In some examples, aspects of the operations of 1815 may be performed by a communication configuration transmitter 730 or a communication configuration transmitter 1130 as described with reference to FIGS. 7 and 11.

At 1820, the method may include receiving a status report in accordance with the set of parameters, the status report indicating whether a current operation of the second device corresponds to one of the respective communication configurations. The operations of 1820 may be performed in accordance with examples as disclosed herein. In some examples, aspects of the operations of 1820 may be performed by a status report receiver 735 or a status report receiver 1135 as described with reference to FIGS. 7 and 11.

At 1825, the method may include comparing, based on the status report, the current operation of the second device to the respective communication configurations to determine whether the current operation of the second device is legitimate. The operations of 1825 may be performed in accordance with examples as disclosed herein. In some examples, aspects of the operations of 1825 may be performed by a legitimacy component 755 or a legitimacy component 1165 as described with reference to FIGS. 7 and 11.

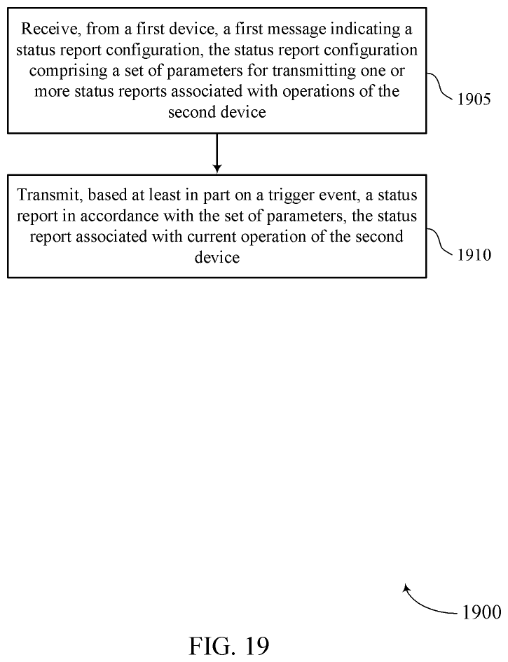

FIG. 19 shows a flowchart illustrating a method 1900 that supports configuration of RIS reporting events in accordance with one or more aspects of the present disclosure. The operations of the method 1900 may be implemented by a device comprising a plurality of reflective elements (e.g., an RIS, an RIS controller) or its components as described herein. For example, the operations of the method 1900 may be performed by a UE 115, a RIS, a RIS controller, or other device, as described with reference to FIGS. 1 through 4 and 13 through 16. In some examples, a device may execute a set of instructions to control the functional elements of the device to perform the described functions. Additionally, or alternatively, the device may perform aspects of the described functions using special-purpose hardware.

At 1905, the method may include receiving, from a first device, a first message indicating a status report configuration, the status report configuration including a set of parameters for transmitting one or more status reports associated with operations of the second device. The operations of 1905 may be performed in accordance with examples as disclosed herein. In some examples, aspects of the operations of 1905 may be performed by a status report configuration receiver 1525 as described with reference to FIG. 15.

At 1910, the method may include transmitting, based on a trigger event, a status report in accordance with the set of parameters, the status report associated with current operation of the second device. The operations of 1910 may be performed in accordance with examples as disclosed herein. In some examples, aspects of the operations of 1910 may be performed by a status report transmitter 1530 as described with reference to FIG. 15.

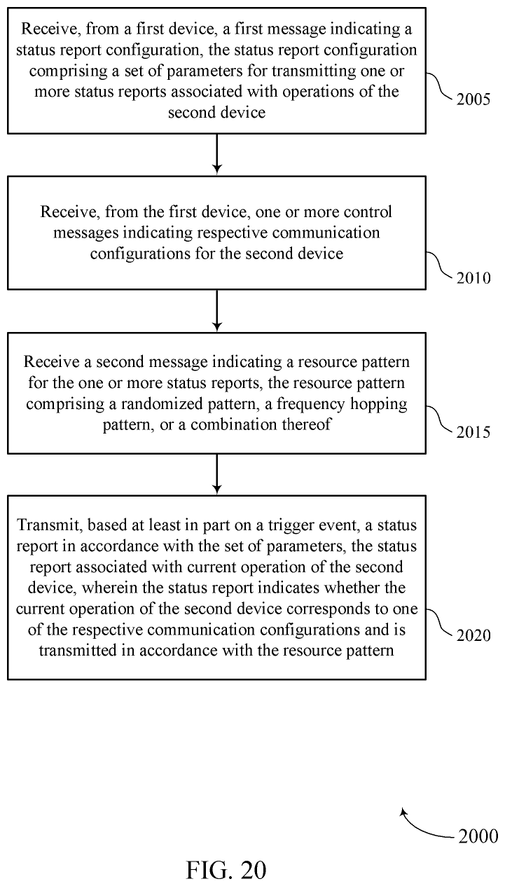

FIG. 20 shows a flowchart illustrating a method 2000 that supports configuration of RIS reporting events in accordance with one or more aspects of the present disclosure. The operations of the method 2000 may be implemented by a device comprising a plurality of reflective elements (e.g., an RIS, an RIS controller) or its components as described herein. For example, the operations of the method 2000 may be performed by a UE 115, a RIS, a RIS controller, or other device, as described with reference to FIGS. 1 through 4 and 13 through 16. In some examples, a device may execute a set of instructions to control the functional elements of the device to perform the described functions. Additionally, or alternatively, the device may perform aspects of the described functions using special-purpose hardware.

At 2005, the method may include receiving, from a first device, a first message indicating a status report configuration, the status report configuration including a set of parameters for transmitting one or more status reports associated with operations of the second device. The operations of 2005 may be performed in accordance with examples as disclosed herein. In some examples, aspects of the operations of 2005 may be performed by a status report configuration receiver 1525 as described with reference to FIG. 15.

At 2010, the method may include receiving, from the first device, one or more control messages indicating respective communication configurations for the second device. The operations of 2010 may be performed in accordance with examples as disclosed herein. In some examples, aspects of the operations of 2010 may be performed by a communication configuration receiver 1535 as described with reference to FIG. 15.

At 2015, the method may include receiving a second message indicating a resource pattern for the one or more status reports, the resource pattern including a randomized pattern, a frequency hopping pattern, or a combination thereof. The operations of 2015 may be performed in accordance with examples as disclosed herein. In some examples, aspects of the operations of 2015 may be performed by a resource pattern component 1545 as described with reference to FIG. 15.

At 2020, the method may include transmitting, based on a trigger event, a status report in accordance with the set of parameters, the status report associated with current operation of the second device, where the status report indicates whether the current operation of the second device corresponds to one of the respective communication configurations and is transmitted in accordance with the resource pattern. The operations of 2020 may be performed in accordance with examples as disclosed herein. In some examples, aspects of the operations of 2020 may be performed by a status report transmitter 1530 as described with reference to FIG. 15.

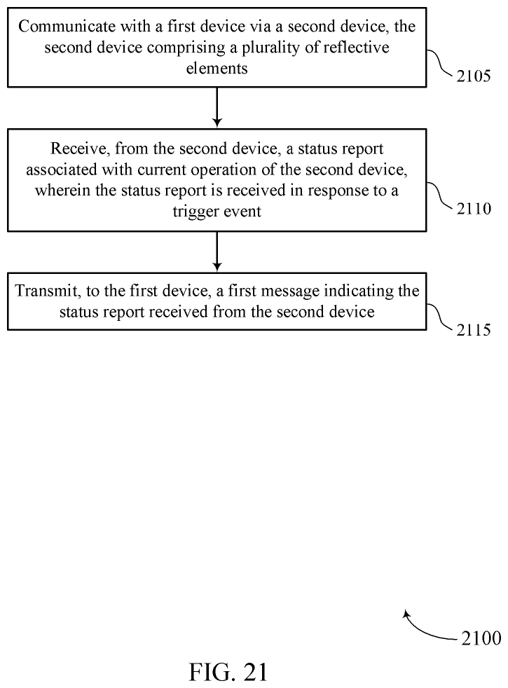

FIG. 21 shows a flowchart illustrating a method 2100 that supports configuration of RIS reporting events in accordance with one or more aspects of the present disclosure. The operations of the method 2100 may be implemented by a UE or its components as described herein. For example, the operations of the method 2100 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 2105, the method may include communicating with a first device via a second device, the second device including a set of multiple reflective elements. The operations of 2105 may be performed in accordance with examples as disclosed herein. In some examples, aspects of the operations of 2105 may be performed by a RIS communication component 1140 as described with reference to FIG. 11.

At 2110, the method may include receiving, from the second device, a status report associated with current operation of the second device, where the status report is received in response to a trigger event. The operations of 2110 may be performed in accordance with examples as disclosed herein. In some examples, aspects of the operations of 2110 may be performed by a status report receiver 1135 as described with reference to FIG. 11.

At 2115, the method may include transmitting, to the first device, a first message indicating the status report received from the second device. The operations of 2115 may be performed in accordance with examples as disclosed herein. In some examples, aspects of the operations of 2115 may be performed by a forwarding component 1145 as described with reference to FIG. 11.

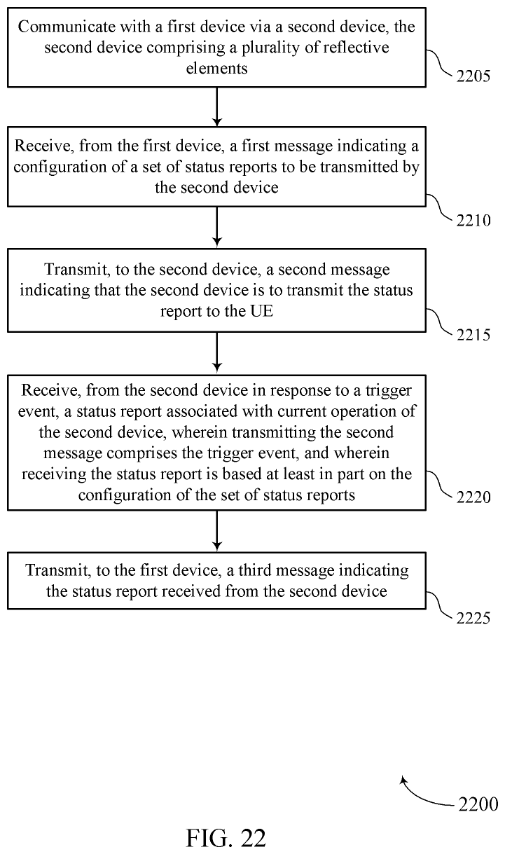

FIG. 22 shows a flowchart illustrating a method 2200 that supports configuration of RIS reporting events in accordance with one or more aspects of the present disclosure. The operations of the method 2200 may be implemented by a UE or its components as described herein. For example, the operations of the method 2200 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 2205, the method may include communicating with a first device via a second device, the second device including a set of multiple reflective elements. The operations of 2205 may be performed in accordance with examples as disclosed herein. In some examples, aspects of the operations of 2205 may be performed by a RIS communication component 1140 as described with reference to FIG. 11.

At 2210, the method may include receiving, from the first device, a third message indicating a configuration of a set of status reports to be transmitted by the second device, where receiving the status report is based on the configuration of the set of status reports. The operations of 2210 may be performed in accordance with examples as disclosed herein. In some examples, aspects of the operations of 2210 may be performed by a status report configuration receiver 1175 as described with reference to FIG. 11.

At 2215, the method may include transmitting, to the second device, a second message indicating that the second device is to transmit the status report to the UE, where transmitting the second message includes the trigger event, and where the status report is received in response to the second message. The operations of 2215 may be performed in accordance with examples as disclosed herein. In some examples, aspects of the operations of 2215 may be performed by a status report manager 1180 as described with reference to FIG. 11.

At 2220, the method may include receiving, from the second device, a status report associated with current operation of the second device, where the status report is received in response to a trigger event. The operations of 2220 may be performed in accordance with examples as disclosed herein. In some examples, aspects of the operations of 2220 may be performed by a status report receiver 1135 as described with reference to FIG. 11.

At 2225, the method may include transmitting, to the first device, a first message indicating the status report received from the second device. The operations of 2225 may be performed in accordance with examples as disclosed herein. In some examples, aspects of the operations of 2225 may be performed by a forwarding component 1145 as described with reference to FIG. 11.

The following provides an overview of aspects of the present disclosure:
Aspect 1: A method for wireless communications at a first device, comprising: transmitting, to a second device comprising a plurality of reflective elements, a first message indicating a status report configuration, the status report configuration comprising a set of parameters for transmitting one or more status reports associated with operations of the second device; transmitting, to the second device, one or more control messages indicating respective communication configurations for the second device; and receiving a status report in accordance with the set of parameters, the status report indicating whether a current operation of the second device corresponds to one of the respective communication configurations.
Aspect 2: The method of aspect 1, further comprising: transmitting, to a third device different from the second device, a second message indicating a configuration of a set of status reports to be transmitted by the second device, wherein the status report is received from the third device based at least in part on the configuration of the set of status reports.
Aspect 3: The method of any of aspects 1 through 2, wherein receiving the status report comprises: receiving the status report from the second device based at least in part on one or more trigger events and the status report configuration.
Aspect 4: The method of any of aspects 1 through 3, wherein the set of parameters comprises a quantity of status reports to be transmitted, a status report periodicity, one or more operating parameters associated with the current operation of the second device to be included in the status report, a trigger event for the status report, a bitmap indicating a mapping between a set of communication configurations and a set of symmetric keys, or a combination thereof.
Aspect 5: The method of aspect 4, wherein the one or more operating parameters comprise a current operating state of the second device, a current configuration of the plurality of reflective elements of the second device, a quantity of communication configurations received at the second device, a list of communication configurations received at the second device, or a combination thereof.
Aspect 6: The method of any of aspects 4 through 5, wherein the trigger event comprises a change in one or more measurement values associated with reception of the one or more control messages at the second device, the one or more measurement values comprising an angle of arrival, a reference signal received power, a reference signal received quality, a signal-to-interference-plus-noise ratio, or a combination thereof.
Aspect 7: The method of any of aspects 1 through 6, further comprising: transmitting, to the second device, a third message indicating a resource pattern for the one or more status reports, the resource pattern comprising a randomized pattern, a frequency hopping pattern, or a combination thereof, wherein the status report is received in accordance with the resource pattern.
Aspect 8: The method of any of aspects 1 through 7, further comprising: transmitting, to the second device, a third message indicating a set of radio network temporary identifiers associated with a radio network temporary identifier pattern for the one or more status reports, the radio network temporary identifier pattern comprising a set of time domain resources corresponding to the set of radio network temporary identifiers, wherein the status report includes a radio network temporary identifier in accordance with the radio network temporary identifier pattern.
Aspect 9: The method of any of aspects 1 through 8, further comprising: generating a signature associated with the first device based at least in part on a symmetric key, the signature comprising a bit sequence, wherein the first message includes the signature.
Aspect 10: The method of aspect 9, wherein the status report further indicates a signature associated with the current operation of the second device based at least in part on a bitmap between a one or more signatures and a current status of the second device.
Aspect 11: The method of any of aspects 1 through 10, further comprising: comparing, based at least in part on the status report, the current operation of the second device to the respective communication configurations to determine whether the current operation of the second device is legitimate.
Aspect 12: A method for wireless communications at a second device comprising a plurality of reflective elements, the method comprising: receiving, from a first device, a first message indicating a status report configuration, the status report configuration comprising a set of parameters for transmitting one or more status reports associated with operations of the second device; and transmitting, based at least in part on a trigger event, a status report in accordance with the set of parameters, the status report associated with current operation of the second device.
Aspect 13: The method of aspect 12, further comprising: receiving, from the first device, one or more control messages indicating respective communication configurations for the second device, wherein the status report indicates whether the current operation of the second device corresponds to one of the respective communication configurations.
Aspect 14: The method of any of aspects 12 through 13, wherein the set of parameters comprises a quantity of status reports, a status report periodicity, one or more operating parameters associated with the operations of the second device, an indication of the trigger event for the status report, a bitmap indicating a mapping between a set of communication configurations and a set of symmetric keys, or a combination thereof.
Aspect 15: The method of aspect 14, wherein the one or more operating parameters comprise a current operating state of the device, a current configuration of the plurality of reflective elements of the device, a quantity of one or more communication configurations received at the second device, a list of communication configurations received at the second device, or a combination thereof.
Aspect 16: The method of any of aspects 14 through 15, wherein the trigger event comprises a change in one or more measurement values associated with reception of one or more control messages at the second device, the one or more measurement values comprising an angle of arrival, a reference signal received power, a reference signal received quality, a signal-to-interference-plus-noise ratio, or a combination thereof.
Aspect 17: The method of aspect 16, further comprising: performing one or more measurements to determine the change in the one or more measurement values based at least in part on receiving the one or more control messages.
Aspect 18: The method of any of aspects 12 through 17, further comprising: receiving a second message indicating a resource pattern for the one or more status reports, the resource pattern comprising a randomized pattern, a frequency hopping pattern, or a combination thereof, wherein the status report is transmitted in accordance with the resource pattern.
Aspect 19: The method of any of aspects 12 through 18, further comprising: receiving a second message indicating a set of radio network temporary identifiers associated with a radio network temporary identifier pattern for the one or more status reports, the radio network temporary identifier pattern comprising a set of time domain resources corresponding to the set of radio network temporary identifiers, wherein the status report includes a radio network temporary identifier in accordance with the radio network temporary identifier pattern.
Aspect 20: The method of any of aspects 12 through 19, wherein the first message further indicates a signature associated with the first device and based at least in part on a symmetric key, and the status report further indicates a signature associated with the current operation of the second device based at least in part on a bitmap between a one or more signatures and a current status of the second device.
Aspect 21: The method of any of aspects 12 through 20, wherein transmitting the status report comprises: transmitting the status report to a third device different from the first device based at least in part on the status report configuration.
Aspect 22: The method of aspect 21, further comprising: receiving a third message from the third device, wherein receiving the third message comprises the trigger event, and wherein transmitting the status report to the third device is in response to receiving the third message.
Aspect 23: A method for wireless communications at a UE, comprising: communicating with a first device via a second device, the second device comprising a plurality of reflective elements; receiving, from the second device, a status report associated with current operation of the second device, wherein the status report is received in response to a trigger event; and transmitting, to the first device, a first message indicating the status report received from the second device.
Aspect 24: The method of aspect 23, further comprising: transmitting, to the second device, a second message indicating that the second device is to transmit the status report to the UE, wherein transmitting the second message comprises the trigger event, and wherein the status report is received in response to the second message.
Aspect 25: The method of aspect 24, wherein the trigger event comprises a change in one or more measurement values associated with reception of one or more control messages, the one or more measurement values comprising an angle of arrival, a reference signal received power, a reference signal received quality, a signal-to-interference-plus-noise ratio, or any combination thereof.
Aspect 26: The method of aspect 25, further comprising: performing one or more measurements to determine the change in the measurement value based at least in part on the one or more control messages.
Aspect 27: The method of any of aspects 24 through 26, further comprising: receiving, from the first device, a third message indicating a configuration of a set of status reports to be transmitted by the second device, wherein receiving the status report is based at least in part on the configuration of the set of status reports.
Aspect 28: An apparatus for wireless communications at a first device, comprising a processor; memory coupled with the processor; and instructions stored in the memory and executable by the processor to cause the apparatus to perform a method of any of aspects 1 through 11.
Aspect 29: An apparatus for wireless communications at a first device, comprising at least one means for performing a method of any of aspects 1 through 11.
Aspect 30: A non-transitory computer-readable medium storing code for wireless communications at a first device, the code comprising instructions executable by a processor to perform a method of any of aspects 1 through 11.
Aspect 31: An apparatus for wireless communications at a second device comprising a plurality of reflective elements, comprising a processor; memory coupled with the processor; and instructions stored in the memory and executable by the processor to cause the apparatus to perform a method of any of aspects 12 through 22.
Aspect 32: An apparatus for wireless communications at a second device comprising a plurality of reflective elements, comprising at least one means for performing a method of any of aspects 12 through 22.
Aspect 33: A non-transitory computer-readable medium storing code for wireless communications at a second device comprising a plurality of reflective elements, the code comprising instructions executable by a processor to perform a method of any of aspects 12 through 22.
Aspect 34: An apparatus for wireless communications at a UE, comprising a processor; memory coupled with the processor; and instructions stored in the memory and executable by the processor to cause the apparatus to perform a method of any of aspects 23 through 27.
Aspect 35: An apparatus for wireless communications at a UE, comprising at least one means for performing a method of any of aspects 23 through 27.
Aspect 36: A non-transitory computer-readable medium storing code for wireless communications at a UE, the code comprising instructions executable by a processor to perform a method of any of aspects 23 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a first device, comprising:
transmitting, to a second device comprising a plurality of reflective elements, a first message indicating a status report configuration, the status report configuration comprising a set of parameters for transmitting one or more status reports associated with operations of the second device;
transmitting, to the second device, one or more control messages indicating respective communication configurations for the second device; and
receiving a status report in accordance with the set of parameters, the status report indicating whether a current operation of the second device corresponds to one of the respective communication configurations.

2. The method of claim 1, further comprising:
transmitting, to a third device different from the second device, a second message indicating a configuration of a set of status reports to be transmitted by the second device, wherein the status report is received from the third device based at least in part on the configuration of the set of status reports.

3. The method of claim 1, wherein receiving the status report comprises:
receiving the status report from the second device based at least in part on one or more trigger events and the status report configuration.

4. The method of claim 1, wherein the set of parameters comprises a quantity of status reports to be transmitted, a status report periodicity, one or more operating parameters associated with the current operation of the second device to be included in the status report, a trigger event for the status report, a bitmap indicating a mapping between a set of communication configurations and a set of symmetric keys, or a combination thereof.

5. The method of claim 4, wherein the one or more operating parameters comprise a current operating state of the second device, a current configuration of the plurality of reflective elements of the second device, a quantity of communication configurations received at the second device, a list of communication configurations received at the second device, or a combination thereof.

6. The method of claim 4, wherein the trigger event comprises a change in one or more measurement values associated with reception of the one or more control messages at the second device, the one or more measurement values comprising an angle of arrival, a reference signal received power, a reference signal received quality, a signal-to-interference-plus-noise ratio, or a combination thereof.

7. The method of claim 1, further comprising:
transmitting, to the second device, a third message indicating a resource pattern for the one or more status reports, the resource pattern comprising a randomized pattern, a frequency hopping pattern, or a combination thereof, wherein the status report is received in accordance with the resource pattern.

8. The method of claim 1, further comprising:
transmitting, to the second device, a third message indicating a set of radio network temporary identifiers associated with a radio network temporary identifier pattern for the one or more status reports, the radio network temporary identifier pattern comprising a set of time domain resources corresponding to the set of radio network temporary identifiers, wherein the status report includes a radio network temporary identifier in accordance with the radio network temporary identifier pattern.

9-11. (canceled)

12. A method for wireless communications at a second device comprising a plurality of reflective elements, the method comprising:
receiving, from a first device, a first message indicating a status report configuration, the status report configuration comprising a set of parameters for transmitting one or more status reports associated with operations of the second device; and
transmitting, based at least in part on a trigger event, a status report in accordance with the set of parameters, the status report associated with current operation of the second device.

13. The method of claim 12, further comprising:
receiving, from the first device, one or more control messages indicating respective communication configurations for the second device, wherein the status report indicates whether the current operation of the second device corresponds to one of the respective communication configurations.

14. The method of claim 12, wherein the set of parameters comprises a quantity of status reports, a status report periodicity, one or more operating parameters associated with the operations of the second device, an indication of the trigger event for the status report, a bitmap indicating a mapping between a set of communication configurations and a set of symmetric keys, or a combination thereof.

15. The method of claim 14, wherein the one or more operating parameters comprise a current operating state of the second device, a current configuration of the plurality of reflective elements of the second device, a quantity of one or more communication configurations received at the second device, a list of communication configurations received at the second device, or a combination thereof.

16. The method of claim 14, wherein the trigger event comprises a change in one or more measurement values associated with reception of one or more control messages at the second device, the one or more measurement values comprising an angle of arrival, a reference signal received power, a reference signal received quality, a signal-to-interference-plus-noise ratio, or a combination thereof.

17. (canceled)

18. The method of claim 12, further comprising:
receiving a second message indicating a resource pattern for the one or more status reports, the resource pattern comprising a randomized pattern, a frequency hopping pattern, or a combination thereof, wherein the status report is transmitted in accordance with the resource pattern.

19. The method of claim 12, further comprising:
receiving a second message indicating a set of radio network temporary identifiers associated with a radio network temporary identifier pattern for the one or more status reports, the radio network temporary identifier pattern comprising a set of time domain resources corresponding to the set of radio network temporary identifiers, wherein the status report includes a radio network temporary identifier in accordance with the radio network temporary identifier pattern.

20. The method of claim 12, wherein:
the first message further indicates a signature associated with the first device and based at least in part on a symmetric key, and
the status report further indicates a signature associated with the current operation of the second device based at least in part on a bitmap between a one or more signatures and a current status of the second device.

21-22. (canceled)

23. A method for wireless communications at a user equipment (UE), comprising:
communicating with a first device via a second device, the second device comprising a plurality of reflective elements;
receiving, from the second device, a status report associated with current operation of the second device, wherein the status report is received in response to a trigger event; and
transmitting, to the first device, a first message indicating the status report received from the second device.

24. The method of claim 23, further comprising:
transmitting, to the second device, a second message indicating that the second device is to transmit the status report to the UE, wherein transmitting the second message comprises the trigger event, and wherein the status report is received in response to the second message.

25. The method of claim 24, wherein the trigger event comprises a change in one or more measurement values associated with reception of one or more control messages, the one or more measurement values comprising an angle of arrival, a reference signal received power, a reference signal received quality, a signal-to-interference-plus-noise ratio, or any combination thereof.

26. (canceled)

27. The method of claim 24, further comprising:
receiving, from the first device, a third message indicating a configuration of a set of status reports to be transmitted by the second device, wherein receiving the status report is based at least in part on the configuration of the set of status reports.

28.-81. (canceled)
